(19) United States
(12) Patent Application Publication
(10) Pub. No.: US 2026/0148513 A1
(43) Pub. Date: May 28, 2026

(54) AUTOMATIC PERSONALIZED AVATAR GENERATION FROM 2D IMAGES

(71) Applicant: Roblox Corporation, San Mateo, CA (US)

(72) Inventors: Eloi DU BOIS, Austin, TX (US); Xiaoxia SUN, San Mateo, CA (US); Charles SHANG, San Mateo, CA (US); Gordon Thomas FINNIGAN, Burlington (CA); Yueqian ZHANG, San Mateo, CA (US); Maurice Kyojin CHU, Redwood City, CA (US); Dario KNEUBUHLER, Lucerne (CH); Emiliano GAMBARETTO, San Francisco, CA (US); Michael Vincent PALLESCHI, Belmont, CA (US); Lukas KUCZYNSKI, San Mateo, CA (US); Hsueh-Ti Derek LIU, Vancouver (CA); Alexander B. WEISS, Pleasanton, CA (US); Jihyun YOON, San Mateo, CA (US); Terrence J. TORRESS, San Mateo, CA (US); Will WELCH, San Francisco, CA (US); Tijmen VERHULSDONCK, Copenhagen (DK); Mahesh Kumar NANDWANA, San Mateo, CA (US); Tinghui ZHOU, San Mateo, CA (US); Yiheng ZHU, Sunnyvale, CA (US); Reza NOURAI, San Mateo, CA (US); Ian SACHS, Corte Madera, CA (US); Mahesh RAMASUBRAMANIAN, San Mateo, CA (US); Kiran BHAT, San Francisco, CA (US); David B. BASZUCKI, Portola Valley, CA (US)

(73) Assignee: Roblox Corporation, San Mateo, CA (US)

(21) Appl. No.: 19/143,130

(22) PCT Filed: Aug. 16, 2024
(86) PCT No.: PCT/US2024/042640

§ 371 Date: Jun. 25, 2025

Related U.S. Application Data
(60) Provisional application No. 63/533,106, filed on Aug. 16, 2023.
(60) Provisional application No. 63/598,936, filed on Nov. 14, 2023.
(60) Provisional application No. 63/656,571, filed on Jun. 5, 2024.

(51) Int. Cl. G06T 19/20; G06T 13/40; G06T 15/04; G06T 17/20

(52) U.S. Cl. CPC G06T 19/20; G06T 13/40; G06T 15/04; G06T 17/20; G06T 2219/2004

(57) ABSTRACT

Implementations described herein relate to methods, systems, apparatuses, and computer-readable media to generate personalized avatars for a user, based on one or more 2D images of a face. The automatic generation may be facilitated by a generative component deployed at a virtual experience server and that is configured to generate a data structure representing a 3D mesh of the personalized avatar responsive to input of the one or more 2D images. The data structure may be converted to a polygonal mesh, and the polygonal mesh may be automatically fit and rigged onto a head portion of an avatar data model.

### CROSS-REFERENCE TO RELATED APPLICATIONS

This application claims priority to § 371 national stage of PCT International Application No. PCT/US24/42640, entitled “AUTOMATIC PERSONALIZED AVATAR GENERATION FROM 2D IMAGES,” filed Aug. 16, 2024, which claims priority to U.S. Provisional Application No. 63/533,106, entitled “FULLY GENERATIVE AVATARS,” filed on Aug. 16, 2023, U.S. Provisional Application No. 63/598,936, entitled “AUTOMATIC PERSONALIZED AVATAR GENERATION FROM 2D IMAGES,” filed on Nov. 14, 2023; and U.S. Provisional Application No. 63/656,571, entitled “AUTOMATIC PERSONALIZED AVATAR GENERATION FROM 2D IMAGES,” filed Jun. 5, 2024, wherein the entire contents of each are incorporated herein in their entirety.

### TECHNICAL FIELD

Embodiments relate generally to computer-based virtual experiences, and more particularly, to methods, systems, and computer readable media for automatic generation of personalized avatars from two dimensional (2D) images.

### BACKGROUND

Some online platforms (e.g., gaming platforms, media exchange platforms, etc.), allow users to connect with each other, interact with each other (e.g., within a game), create games, and share information with each other via the Internet. Users of online platforms may participate in multiplayer gaming environments or virtual environments (e.g., three-dimensional environments), design custom gaming environments, design characters and avatars, decorate avatars, exchange virtual items/objects with other users, communicate with other users using audio or text messaging, and so forth. Users interacting with one another may use interactive interfaces that include presentation of a user's avatar. Customizing the avatar to recreate a user's facial features may conventionally include having a user create a complex three-dimensional (3D) mesh using a computer-aided design tool or other tools. For example, creating avatars or characters involves a series of intricate stages, each demanding significant manual effort, specialized knowledge, and proficiency with specific software tools. These stages encompass tasks such as shaping meshes, applying textures, setting up rigging and skinning, defining structural frameworks, and segmenting components. Such conventional solutions suffer drawbacks, and some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, systems, apparatuses, and computer-readable media to generate personalized avatars for a user, based on one or more 2D images of a face. The automatic generation may be facilitated by a generative component deployed at a virtual experience server and that is configured to generate a data structure representing a 3D mesh of the personalized avatar responsive to input of the one or more 2D images. The data structure may be converted to a polygonal mesh, and automatically fit and rigged onto a head portion of an avatar data model.

According to yet another aspect, portions, features, and implementation details of the systems, methods, apparatuses, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF THE DRAWINGS

FIG. 1 is a diagram of an example network environment, in accordance with some implementations.

FIG. 2A is a block diagram that illustrates an example generative pipeline of the generative component of FIG. 1, in accordance with some implementations.

FIG. 2B is a block diagram that illustrates an example of individual components of the example pipeline of FIG. 2A, in accordance with some implementations.

FIG. 2C is a block diagram that illustrates another example of individual components of the example pipeline of FIG. 2A, in accordance with some implementations.

FIG. 2D is a block diagram that illustrates another example of individual components of the example pipeline of FIG. 2A, in accordance with some implementations.

FIG. 3A is a block diagram that illustrates an example training architecture of the example pipeline of FIG. 2A, in accordance with some implementations.

FIG. 3B is a block diagram that illustrates an example training architecture of the example components of FIG. 2B, in accordance with some implementations.

FIG. 3C is a block diagram that illustrates an example training architecture of the example components of FIG. 2C, in accordance with some implementations.

FIG. 3D is a block diagram that illustrates an example training architecture of the example components of FIG. 2D, in accordance with some implementations.

FIG. 3E is a block diagram that illustrates an example training architecture of a conditional model, in accordance with some implementations.

FIG. 4A is a block diagram of a mapping network, in accordance with some implementations.

FIG. 4B is a block diagram of an example content mapping decoder of the mapping network of FIG. 4A, in accordance with some implementations.

FIG. 4C is a block diagram of another example content mapping decoder of the mapping network of FIG. 4A, in accordance with some implementations.

FIG. 5 is a block diagram of an example opacity decoder, in accordance with some implementations.

FIG. 6 is a block diagram of an example conditional model, in accordance with some implementations.

FIG. 7 is a flowchart of an example method to train the example generative pipeline of FIG. 2A, in accordance with some implementations.

FIG. 8 is a flowchart of an example method to train an unconditional model having a GAN generator, in accordance with some implementations.

FIG. 9 is a flowchart of an example method to train an unconditional model having a Dual-GAN generator, in accordance with some implementations.

FIG. 10 is a flowchart of an example method of automatic personalized avatar generation from 2D images, in accordance with some implementations.

FIG. 11 is a flowchart of another example method of automatic personalized avatar generation from 2D images, in accordance with some implementations.

FIG. 12 is a block diagram illustrating an example computing device that may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

In some aspects, systems and methods are provided for automatic personalized avatar generation from 2D images. Features can include automatically creating a 3D mesh of an avatar face, based upon one or more input images and text prompt responses received from a client device, and rigging the 3D mesh onto an avatar data model for display within a virtual experience. The automatic generation may include generation of one or more feature vectors by one or more machine-learning models, where the generation is based upon input images of a face as well as answers/prompts provided by the user to one or more prompts posed to the user. The one or more prompts may be prompts to describe features, styles, and other attributes the user desires that the personalized avatar be based upon.

In some implementations, the one or more input images depict a human face. In these implementations, users are provided guidance regarding how the images are stored (e.g., temporarily in memory, for a period of a day, etc.) and used (for the specific purpose of generation of a 3D mesh of an avatar face). Users may choose to proceed with creating a 3D mesh by providing input images or choose to not provide input images. If the user chooses to not provide input images, 3D mesh generation is performed without use of input images (e.g., based on stock images, based on the text prompt, or using other techniques that do not use input images). Input images are used only for 3D mesh generation and are destroyed (deleted from memory and storage) upon completion of the generation. Input-image based 3D mesh generation features are provided only in legal jurisdictions where use of input images that depict a face, and various operations related to use of the face in avatar generation are permitted according to local regulations. In jurisdictions where such use is not permitted (e.g., storage of facial data is not permitted), face-based 3D mesh generation is not implemented. Additionally, face-based 3D mesh generation is implemented for specific sets of users, e.g., adults (e.g., over 18 years old, over 21 years old, etc.) that provide legal consent for use of input images and facial data. Users are provided with options to delete 3D meshes generated from input images and in response to user selection of the options, the 3D meshes (and any associated data, including input images, if stored) are removed from memory and storage. Face information from the input images is used specifically for 3D mesh generation and in accordance with terms and conditions under which such information was obtained.

For example, a user may want to generate a caricature or other stylized depiction of their face. In these examples, the answers/prompts to the one or more prompts may include “caricature,” “cartoon,” and/or other answers/prompts.

For example, a user may desire to alter a personal style to match a popular or other style. In these examples, the answers/prompts to the one or more prompts may include “popular culture,” “rock star,” and/or other answers/prompts.

For example, a user may desire to alter a physical appearance to avoid or accent certain personal features. In these examples, the answers/prompts to the one or more prompts may include “full head of hair,” “bald,” “large eyes,” and/or other answers/prompts.

For example, a user may desire to alter a physical appearance such that a style of a movie or television series is matched or mimicked. In these examples, the answers/prompts to the one or more prompts may include “Popeye,” “Addams Family,” and/or other answers/prompts.

For example, a user may desire a plurality of different features to be considered such that an automatically generated avatar may depict the plurality of different features in combination. In these examples, the answers/prompts to the one or more prompts may include “add more hair,” “smaller face,” “cartoon skin,” and/or other answers/prompts.

Features described herein provide automatic generation of vectors representing a face detected in a 2D image, automatic generation of one or more vectors (e.g., a conditional density sampling vector) based on answers/prompts to one or more prompts and/or the detected face, generation of a 3D mesh based upon the generated vectors, and the automatic rigging of the 3D mesh onto an avatar data model and/or skeletal frame.

A generative component is trained to accurately generate the feature vectors, including conditional density sampling, and a 3D mesh. The training may include independent training of a 2D generative component configured to output a computer-generated (CG) representation of a face, and training of a 2D to 3D generative component configured to generate a 3D polygonal mesh based on the CG representation. In some implementations, the 2D generative component may be replaced with a sequence of selectable 2D CG images for user selection of a starting face. In some implementations, the 2D to 3D generative component may include a generative network formed with a conditional model and an unconditional model. In some implementations, the unconditional model may include a Generative-Adversarial Network (GAN) Generator which includes at least one GAN model. In some implementations, the unconditional model may include a dual-GAN Generator which includes at least two GAN models.

In some implementations, the training may include independent training of a neural network configured to output a computer-generated representation of a user's face, training of a style encoder to generate a vector from conditional density sampling of desired style characteristics/answers/prompts to the one or more prompts, and training of a GAN Generator component. Thereafter, the trained models may be used to automatically generate an avatar for the user using an output 3D mesh created from an output provided by the GAN generator.

In some implementations, the training may include independent training of a neural network configured to output a computer-generated representation of a user's face, training of a style encoder to generate a vector from conditional density sampling of desired style characteristics/answers/prompts to the one or more prompts, and training of a dual-GAN Generator component. Thereafter, the trained models may be used to automatically generate an avatar for the user using an output 3D mesh created from an output provided by the dual-GAN Generator.

The trained models may be deployed at server devices or client devices for use by users requesting to have automatically created avatars based on personalized preferences. The client devices may be configured to be in operative communication with online platforms, such as a virtual experience platform, whereby their associated avatars may be richly animated for presentation in communication interfaces (e.g., video chat), within virtual experiences (e.g., customized faces on a representative virtual body), within animated videos transmitted to other users (e.g., by sending recordings or renderings of the avatars through a chat function or other functionality), and within other portions of the online platforms.

Online virtual experience platforms (also referred to as “user-generated content platforms” or “user-generated content systems”) offer a variety of ways for users to interact with one another. For example, users of an online virtual experience platform may create experiences, games, or other content or resources (e.g., characters, graphics, items for game play within a virtual world, etc.) within the platform.

Users of an online virtual experience platform may work together towards a common goal in a game or in game creation, share various virtual items, send electronic messages to one another, and so forth. Users of an online virtual experience platform may interact with an environment, play games, e.g., including characters (avatars) or other game objects and mechanisms. An online virtual experience platform may also allow users of the platform to communicate with each other. For example, users of the online virtual experience platform may communicate with each other using voice messages (e.g., via voice chat), text messaging, video messaging, or a combination of the above. Some online virtual experience platforms can provide a virtual 3D environment in which users can represent themselves using an avatar or virtual representation of themselves.

In order to help enhance the entertainment value of an online virtual experience platform, the platform can provide a generative component to facilitate automatically generating avatars based on user preferences. The generative component may allow users to request features, answer prompts, or select options for generation, including, for example, plain text descriptions of desired features for the automatically generated avatar.

For example, a user can allow camera access by an application on the user device associated with the online virtual experience platform. The images captured at the camera may be interpreted to extract features or other information that facilitates generation of a basic 2D representation of the face based upon the extracted gestures. Similarly, users may augment generation through input of answers/prompts to one or more prompts. Thereafter, a stylized depiction of the face may be generated as a 3D mesh useable within a virtual experience platform (or other platforms) to create a personalized avatar.

However, in conventional solutions, automatic generation of customized or personalized avatars is limited due to lack of sufficient computing resources on many mobile client devices. For example, many users may use portable computing devices (e.g., ultra-light portables, tablets, mobile phones, etc.) that lack sufficient computational power to rapidly interpret facial features and prompts to accurately create customized computer-generated images. In these circumstances, many automated generation components suffer from drawbacks including increased render time (e.g., upwards of half-an-hour to many hours), decreased graphics quality (e.g., in an attempt to reduce render time), and others.

Thus, while some users may acquire mobile devices or computing devices with sufficient processing power to handle robust generative models through conventional solutions, many users lack these experiences due to utilization of otherwise suitable devices that lack sufficient computational resources for complex computer vision processing.

In these scenarios, various implementations described herein leverage a back-end server capable of providing processing capabilities for more complex generative tasks, while a compact user-customized model or models may be deployed at client devices to create a personalized encoding of facial features from input 2D images. Accordingly, example embodiments provide technical benefits including reduced computational resource use at client devices, improved data processing flow from client devices to servers deploying trained models and generative components, improved user engagement through intelligent prompts for style preferences, as well as other technical benefits and effects which will become apparent throughout this disclosure.

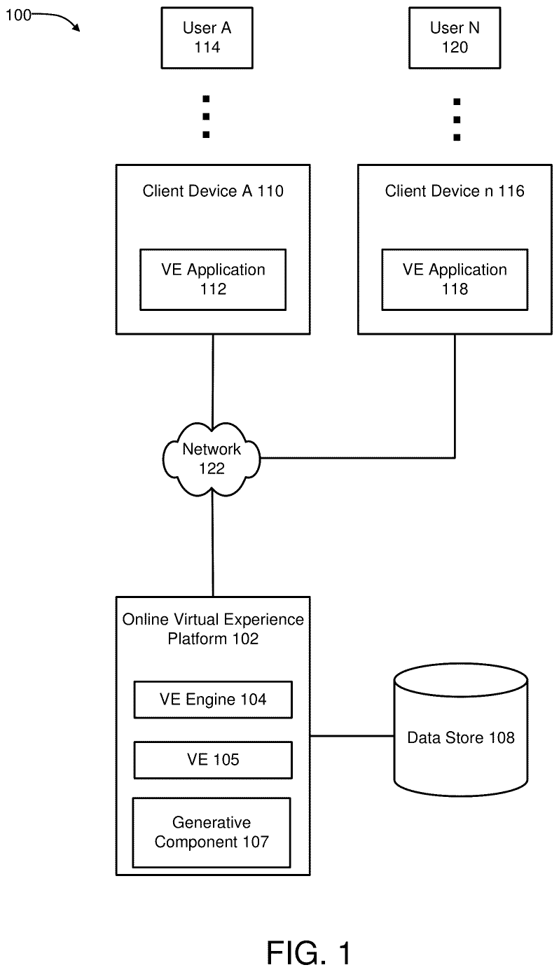

### FIG. 1: System Architecture

FIG. 1 illustrates an example network environment 100, in accordance with some implementations of the disclosure. The network environment 100 (also referred to as “system” herein) includes an online virtual experience platform 102, a first client device 110, a second client device 116 (generally referred to as “client devices 110/116” herein), all connected via a network 122. The online virtual experience platform 102 can include, among other things, a virtual experience (VE) engine 104, one or more virtual experiences 105, a generative component 107, and a data store 108. The client device 110 can include a virtual experience application 112. The client device 116 can include a virtual experience application 118. Users 114 and 120 can use client devices 110 and 116, respectively, to interact with the online virtual experience platform 102.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience platform 102 can include a server having one or more computing devices (e.g., a cloud computing system, a rackmount server, a server computer, cluster of physical servers, virtual server, etc.). In some implementations, a server may be included in the online virtual experience platform 102, be an independent system, or be part of another system or platform.

In some implementations, the online virtual experience platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience platform 102 and to provide a user with access to online virtual experience platform 102. The online virtual experience platform 102 may also include a website (e.g., one or more webpages) or application back-end software that may be used to provide a user with access to content provided by online virtual experience platform 102. For example, users may access online virtual experience platform 102 using the virtual experience application 112/118 on client devices 110/116, respectively.

In some implementations, online virtual experience platform 102 may include a type of social network providing connections between users or a type of user-generated content system that allows users (e.g., end-users or consumers) to communicate with other users via the online virtual experience platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience platform 102 may be a virtual gaming platform. For example, the gaming platform may provide single-player or multiplayer games to a community of users that may access or interact with games (e.g., user generated games or other games) using client devices 110/116 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may search for games and game items, and participate in gameplay with other users in one or more games. In some implementations, a game may be played in real-time with other users of the game.

In some implementations, other collaboration platforms can be used with the generative features described herein instead of or in addition to online virtual experience platform 102. For example, a social networking platform, video chat platform, messaging platform, user content creation platform, virtual meeting platform, etc. can be used with the generative features described herein to facilitate rapid, robust, and accurate generation of a personalized virtual avatar.

In some implementations, “gameplay” may refer to interaction of one or more players using client devices (e.g., 110 and/or 116) within a game or experience (e.g., VE 105) or the presentation of the interaction on a display or other output device of a client device 110 or 116.

One or more virtual experiences 105 are provided by the online virtual experience platform. In some implementations, a virtual experience 105 can include an electronic file that can be executed or loaded using software, firmware or hardware configured to present virtual content (e.g., digital media items) to an entity. In some implementations, a virtual experience application 112/118 may be executed and a virtual experience 105 rendered in connection with a virtual experience engine 104. In some implementations, a virtual experience 105 may have a common set of rules or common goal, and the environments of a virtual experience 105 share the common set of rules or common goal. In some implementations, different virtual experiences may have different rules or goals from one another. Similarly, or alternatively, some virtual experiences may lack goals altogether, with an intent being the interaction between users in any social manner.

In some implementations, virtual experiences may have one or more environments (also referred to as “gaming environments” or “virtual environments” herein) where multiple environments may be linked. An example of an environment may be a three-dimensional (3D) environment. The one or more environments of a virtual experience 105 may be collectively referred to a “world” or “virtual world” or “virtual universe” or “metaverse” herein. An example of a world may be a 3D world of a virtual experience 105. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual content (or at least present content to appear as 3D content whether or not 3D representation of geometric data is used). 2D environments or 2D worlds use graphics that use two-dimensional representation of geometric data representative of virtual content.

In some implementations, the online virtual experience platform 102 can host one or more virtual experiences 105 and can permit users to interact with the virtual experiences 105 (e.g., search for games, VE-related content, or other content) using a virtual experience application 112/118 of client devices 110/116. Users (e.g., 114 and/or 120) of the online virtual experience platform 102 may play, create, interact with, or build virtual experiences 105, search for virtual experiences 105, communicate with other users, create and build objects (e.g., also referred to as “item(s)” or “game objects” or “virtual game item(s)” herein) of virtual experiences 105, and/or search for objects. For example, in generating user-generated virtual items, users may create characters, decoration for the characters, one or more virtual environments for an interactive experience, or build structures used in a virtual experience 105, among others.

In some implementations, users may buy, sell, or trade virtual objects, such as in-platform currency (e.g., virtual currency), with other users of the online virtual experience platform 102. In some implementations, online virtual experience platform 102 may transmit virtual content to virtual experience applications (e.g., 112, 118). In some implementations, virtual content (also referred to as “content” herein) may refer to any data or software instructions (e.g., virtual objects, experiences, user information, video, images, commands, media item, etc.) associated with online virtual experience platform 102 or virtual experience applications.

In some implementations, virtual objects (e.g., also referred to as “item(s)” or “objects” or “virtual game item(s)” herein) may refer to objects that are used, created, shared or otherwise depicted in virtual experience applications 105 of the online virtual experience platform 102 or virtual experience applications 112 or 118 of the client devices 110/116. For example, virtual objects may include a part, model, character, tools, weapons, clothing, buildings, vehicles, currency, flora, fauna, components of the aforementioned (e.g., windows of a building), and so forth.

It may be noted that the online virtual experience platform 102 hosting virtual experiences 105, is provided for purposes of illustration, rather than limitation. In some implementations, online virtual experience platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 105 may be associated with a particular user or a particular group of users (e.g., a private experience), or made widely available to users of the online virtual experience platform 102 (e.g., a public experience). In some implementations, where online virtual experience platform 102 associates one or more virtual experiences 105 with a specific user or group of users, online virtual experience platform 102 may associated the specific user(s) with a virtual experience 105 using user account information (e.g., a user account identifier such as username and password). Similarly, in some implementations, online virtual experience platform 102 may associate a specific developer or group of developers with a virtual experience 105 using developer account information (e.g., a developer account identifier such as a username and password).

In some implementations, online virtual experience platform 102 or client devices 110/116 may include a virtual experience engine 104 or virtual experience application 112/118. The virtual experience engine 104 can include a virtual experience application similar to virtual experience application 112/118. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.). In some implementations, virtual experience applications 112/118 of client devices 110/116, respectively, may work independently, in collaboration with virtual experience engine 104 of online virtual experience platform 102, or a combination of both.

In some implementations, both the online virtual experience platform 102 and client devices 110/116 execute a virtual experience engine (104, 112, and 118, respectively). The online virtual experience platform 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 105 may have a different ratio between the virtual experience engine functions that are performed on the online virtual experience platform 102 and the virtual experience engine functions that are performed on the client devices 110 and 116.

For example, the virtual experience engine 104 of the online virtual experience platform 102 may be used to generate physics commands in cases where there is a collision between at least two game objects, while the additional virtual experience engine functionality (e.g., generate rendering commands) may be offloaded to the client device 110. In some implementations, the ratio of virtual experience engine functions performed on the online virtual experience platform 102 and client device 110 may be changed (e.g., dynamically) based on interactivity conditions. For example, if the number of users participating in a virtual experience 105 exceeds a threshold number, the online virtual experience platform 102 may perform one or more virtual experience engine functions that were previously performed by the client devices 110 or 116.

For example, users may be interacting with a virtual experience 105 on client devices 110 and 116, and may send control instructions (e.g., user inputs, such as right, left, up, down, user election, or character position and velocity information, etc.) to the online virtual experience platform 102. Subsequent to receiving control instructions from the client devices 110 and 116, the online virtual experience platform 102 may send interaction instructions (e.g., position and velocity information of the characters participating in the virtual experience or commands, such as rendering commands, collision commands, etc.) to the client devices 110 and 116 based on control instructions. For instance, the online virtual experience platform 102 may perform one or more logical operations (e.g., using virtual experience engine 104) on the control instructions to generate interaction instruction for the client devices 110 and 116. In other instances, online virtual experience platform 102 may pass one or more or the control instructions from one client device 110 to other client devices (e.g., 116) participating in the virtual experience 105. The client devices 110 and 116 may use the instructions and render the experience for presentation on the displays of client devices 110 and 116.

In some implementations, the control instructions may refer to instructions that are indicative of in-experience actions of a user's character or avatar. For example, control instructions may include user input to control the in-experience action, such as right, left, up, down, user selection, gyroscope position and orientation data, force sensor data, etc. The control instructions may include character position and velocity information. In some implementations, the control instructions are sent directly to the online virtual experience platform 102. In other implementations, the control instructions may be sent from a client device 110 to another client device (e.g., 116), where the other client device generates play instructions using the local virtual experience engine 104. The control instructions may include instructions to play a voice communication message or other sounds from another user on an audio device (e.g., speakers, headphones, etc.), move a character or avatar, and other instructions.

In some implementations, interaction or play instructions may refer to instructions that allow a client device 110 (or 116) to render movement of elements of a virtual experience, such as a multiplayer game. The instructions may include one or more of user input (e.g., control instructions), character position and velocity information, or commands (e.g., physics commands, rendering commands, collision commands, etc.). As described more fully herein, other instructions may include facial animation instructions extracted through analysis of an input video of a face, to direct the animation of a representative virtual face of a virtual avatar, in real-time. Accordingly, while interaction instructions may include input by a user to directly control some body motion of a character, interaction instructions may also include gestures extracted from video of a user.

In some implementations, characters (or virtual objects generally) are constructed from components, one or more of which may be selected by the user, that automatically join together to aid the user in editing. One or more characters (also referred to as an “avatar” or “model” herein) may be associated with a user where the user may control the character to facilitate a user's interaction with the virtual experience 105. In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools. Some or all of these components may be generated automatically with the features described herein.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character object (e.g., body parts, etc.) but the user may control the character (without the character object) to facilitate the user's interaction with a game (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience platform 102. In some implementations, creating, modifying, or customizing characters, other virtual objects, virtual experiences 105, or virtual environments may be performed by a user using a user interface (e.g., developer interface) and with or without scripting (or with or without an application programming interface (API)). It may be noted that for purposes of illustration, rather than limitation, characters are described as having a humanoid form. It may further be noted that characters may have any form such as a vehicle, animal, inanimate object, or other creative form.

In some implementations, the online virtual experience platform 102 may store characters created by users in the data store 108. In some implementations, the online virtual experience platform 102 maintains a character catalog and experience catalog that may be presented to users via the virtual experience engine 104, virtual experience 105, and/or client device 110/116. In some implementations, the experience catalog includes images of different experiences stored on the online virtual experience platform 102. In addition, a user may select a character (e.g., a character created by the user or other user) from the character catalog to participate in the chosen experience. The character catalog includes images of characters stored on the online virtual experience platform 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings and/or personalized settings as described herein. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience platform 102.

In some implementations, a user may also input character settings and/or style and/or personal preferences as one or more answers/prompts to one or more prompts. These answers/prompts may be used by a trained neural network and a trained style encoder to create feature vectors for automatic generation of a 3D mesh representative of those character settings and/or style and/or personal preferences by a GAN generator and/or dual-GAN generator, as described herein.

In some implementations, a user may also select from a catalog of CG images as a starting or reference point in generating a customized avatar. The CG images may be displayed to the user in the VE application 112 or 118, and the user may select at least one CG image. Thereafter, the user may be provided with one or more prompts for customization of the avatar resulting from the selected CG image. For example, one or more prompts such as “which hair style do you prefer?” or “is there a celebrity you want your avatar to resemble?” may be displayed. The user may type natural language text as an answer to any prompt, which is used by the system 100 to generate appropriate feature vectors and/or to select additional CG images from a repository of images to generate feature vectors representing those traits that match the user's answers/prompts. These feature vectors and the selected CG image may be used by 2D to 3D generative component to automatically generate a mesh for fitting onto an avatar for the user that displays traits based on the selected CG image as well as the user's answers/prompts.

In some implementations, a user may also allow camera access and take a sequence of “selfies” (e.g., one or more images containing their face). A trained neural network may then create a CG image based on the selfies for input into a 2D to 3D generative component. It is noted that user answers to prompts may also be used in this example. The generated CG image of the face as well as any user answers to prompts may be input to the 2D to 3D generative component to automatically generate a mesh for fitting onto an avatar for the user that displays traits based on the CG image of the face as well as the user's answers/prompts.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online virtual experience platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the virtual experience application 112 or 118, respectively. In one implementation, the virtual experience application 112 or 118 may permit users to use and interact with online virtual experience platform 102, such as search for a particular experience or other content, control a virtual character in a virtual game hosted by online virtual experience platform 102, or view or upload content, such as virtual experiences 105, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a program) that is installed and executes local to client device 110 or 116 and allows users to interact with online virtual experience platform 102. The virtual experience application may render, display, or present the content (e.g., a web page, a user interface, a media viewer) to a user. In an implementation, the virtual experience application may also include an embedded media player (e.g., a Flash® player) that is embedded in a web page.

According to aspects of the disclosure, the virtual experience application 112/118 may be an online virtual experience platform application for users to build, create, edit, upload content to the online virtual experience platform 102 as well as interact with online virtual experience platform 102 (e.g., play and interact with virtual experience 105 hosted by online virtual experience platform 102). As such, the virtual experience application 112/118 may be provided to the client device 110 or 116 by the online virtual experience platform 102. In another example, the virtual experience application 112/118 may be an application that is downloaded from a server.

In some implementations, a user may login to online virtual experience platform 102 via the virtual experience application. The user may access a user account by providing user account information (e.g., username and password) where the user account is associated with one or more characters available to participate in one or more virtual experiences 105 of online virtual experience platform 102.

In general, functions described as being performed by the online virtual experience platform 102 can also be performed by the client device(s) 110 or 116, or a server, in other implementations if appropriate. In addition, the functionality attributed to a particular component can be performed by different or multiple components operating together. The online virtual experience platform 102 can also be accessed as a service provided to other systems or devices through appropriate application programming interfaces (APIs), and thus is not limited to use in websites.

In some implementations, online virtual experience platform 102 may include a generative component 107. In some implementations, the generative component 107 may be a system, application, pipeline, and/or module that leverages several trained models to automatically generate a user's avatar or character face based on selected images, personal images, personalized preferences, character settings, and/or answers/prompts. The generative component 107 may include a pipeline having a 2D to 3D generative AI component, in some implementations. The generative component 107 may include a trained conditional model and a trained unconditional model, in some implementations. The generative component 107 may include a trained style encoder and a GAN generator in some implementations. The generative component 107 may include a trained style and/or content encoder and a dual-GAN generator in some implementations.

The generation by the generative component 107 may be based upon a user selection of a CG image provided by the system 100, in some implementations. For example, a plurality of CG images may be displayed for selection by the user. The user may make selections of different styles, provide answers to style prompts, and/or provide other personal preferences.

The generation by the generative component 107 may also be based upon a user's actual face, and as such, may include several features extracted from the face (e.g., via an input image) while also including features and styles defined in the user's preferences and/or answers/prompts. In situations in which these and other certain implementations discussed herein may obtain or use user data (e.g., images of users, user demographics, user answers to prompts, user self-description, etc.) users are provided with options to control whether and how such information is collected, stored, or used. That is, the implementations discussed herein collect, store and/or use user information upon receiving explicit user authorization and in compliance with applicable regulations.

Furthermore, users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed.

While illustrated as being executed directly on the online virtual experience platform 102, it should be understood that the described trained models may be implemented on each client device 110, 116, for example, in some implementations. Furthermore, in some implementations, one trained model may be deployed at a client device while another trained model may be deployed at the platform 102.

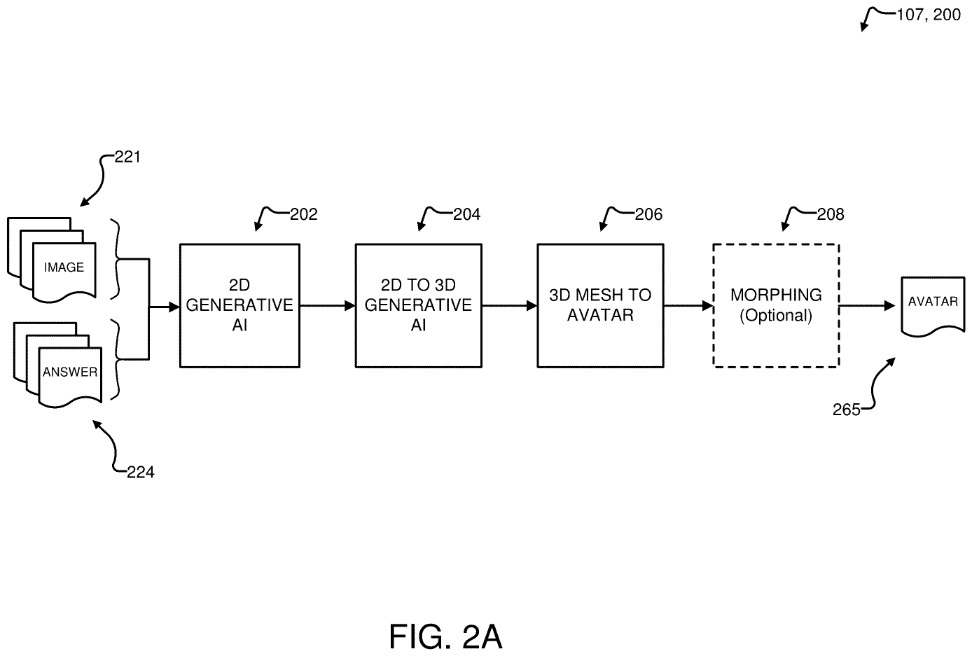

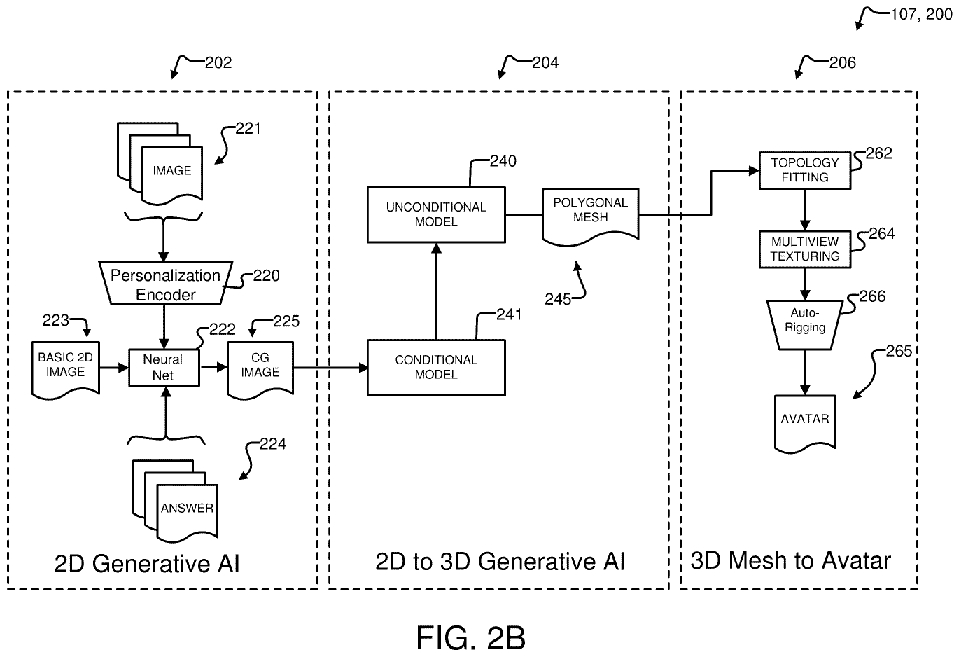

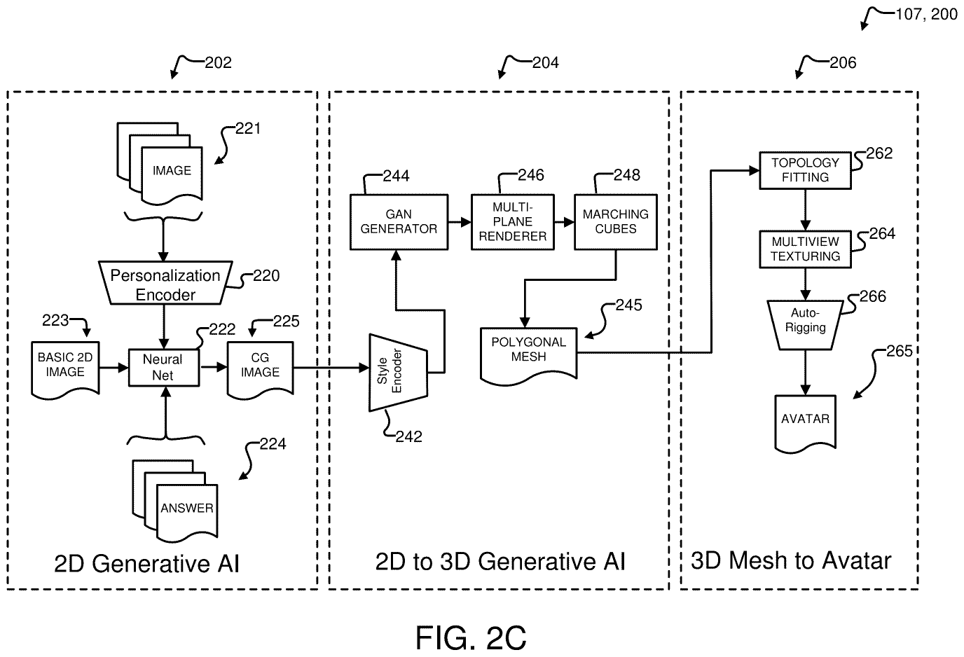

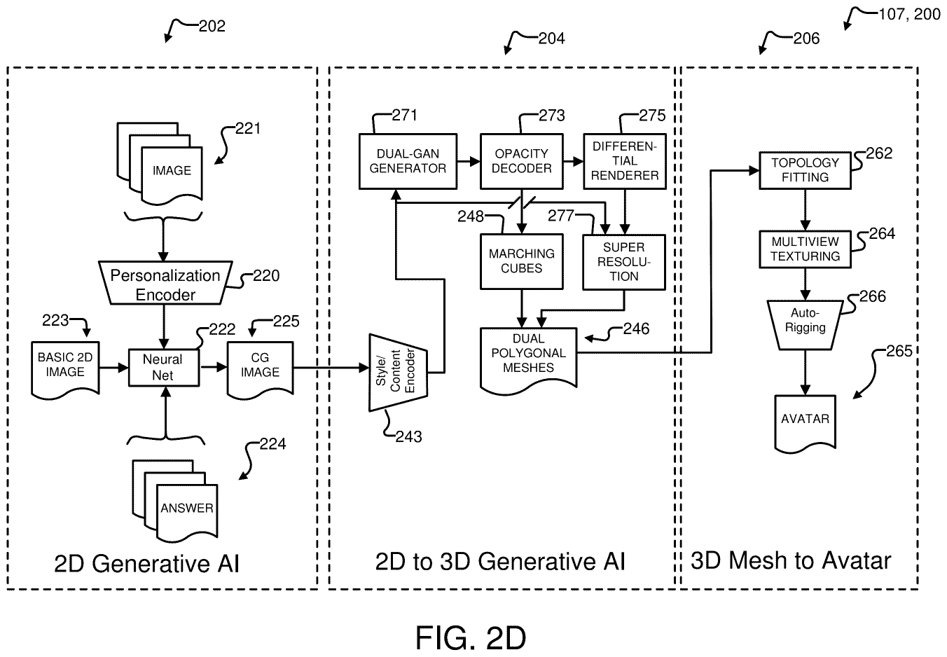

Hereinafter, example components of the generative component 107 are described more fully with reference to FIGS. 2A-2E.

### FIG. 2A: Generative Pipeline

FIG. 2A is a block diagram that illustrates an example generative pipeline of the generative component 107 of FIG. 1, in accordance with some implementations. The generative pipeline is referred to as pipeline 200, but may be used interchangeably as the generative component 107 in some implementations.

The pipeline 200 may include three or more stages/components. For example, the pipeline 200 may include a 2D generative AI stage 202, a 2D to 3D generative AI stage 204, a 3D mesh to avatar stage 206, and/or an optional morphing stage 208. In general, a series of images 221 and a set of user answers/prompts to various prompts 224 may be provided as input to the pipeline 200. The pipeline 200 may output a finished avatar 265. The output avatar 265 may be useable at the platform 102 and/or other platforms as a fully-animatable avatar, avatar head, and/or avatar head, body, clothing, accessories, etc.

In some implementations, one or more of the stages are trained independently of other stages. In some implementations, the stages are trained at least partially in parallel (or jointly). In some implementations, the stages are trained in parallel (or jointly).

The 2D generative AI stage 202 may include one or more models trained to output a CG image generated based on the images 221 or a combination of the images 221 and the user answers/prompts 224. The CG image may be output by the 2D generative AI stage and input by the 2D to 3D generative AI stage 204.

In some implementations, the 2D generative AI stage 202 may be omitted entirely, and user selections of a plurality of CG images may be used instead. For example, if a user does not wish to provide images of their face, or if the user otherwise prefers to start with a different example image, the user may select a computer-generated image to use in avatar generation. For example, a plurality of different GC images may be displayed on a user interface. The user may select an image which may then be used as the CG image input by the stage 204.

The 2D to 3D generative AI stage 204 may include one or more models trained to output a polygonal mesh representing a CG image (e.g., either provided by stage 202 or a user-selection). For example, the stage 204 may generate feature vectors, generate a data structure (such as a tri-plane or tri-grid) based on the feature vectors, and produce the polygonal mesh based on the generated data structure. The data structure may also include a polygonal mesh depending upon a configuration of trained models deployed within the stage 204. For example, if a GAN generator is deployed, the GAN generator may be trained to output a tri-plane or tri-grid that can be directly converted into a high-fidelity 3D polygonal mesh. For example, if a rendering layer is integrated with the GAN generator, the rendering layer may directly output a polygonal mesh based on an internal tri-plane or tri-grid representation.

In some implementations, the data structure may also include two or more tri-planes or tri-grids. For example, if a dual-GAN generator is deployed, each GAN generator of the dual-GAN generator may output an individual tri-plane or tri-grid that each represent a different part of a head (e.g., bald head and hair). In this example, semantic operations may be leveraged to create two or more polygonal meshes akin to “building blocks”. For example, if one tri-plane represents a bald head, and a second tri-plane represents hair, both a bald head mesh and a non-bald head mesh may be output. In some implementations, both a bald head mesh and a mesh of only hair may also be output. Therefore, the stage 204 may be configurable to provide several different meshes that may be selectable to create an avatar that can be uniquely customized by removing hair features that exist in input images, and replaced with either bald heads or different hair styles and/or accessories.

The 3D polygonal mesh may be output by the 2D to 3D generative stage 204 and input by the 3D mesh to avatar stage 206.

The 3D mesh to avatar stage 206 may include one or more models trained to automatically fit and rig the polygonal mesh to an avatar head and/or body. In this manner, the stage 206 is configured for automatic placement, fitment, and rigging of a polygonal mesh onto an avatar body or skeleton. For example, the output polygonal mesh 245 may be input by a topology fitting algorithm to adjust the mesh for a particular avatar head topology, to a multiview texturing algorithm to create a textured 3D mesh that is fit for rigging onto an avatar head data model, and the textured 3D mesh may then be provided as input to an automatic rigging algorithm to appropriately rig the textured 3D mesh onto an avatar head as output 265. In some implementations, the stage 206 may also take two meshes output from the stage 204 and join them or assemble them to create a single mesh (e.g., join a bald head mesh with a hair mesh). In this manner, unique and user-customizable hair styles may be implemented on automatically generated avatars with reduced computational cycles as compared to other conventional solutions which output meshes that inherently join hair and head, with no easy manner of removing or replacing hair. In some implementations, both meshes are joined at stage 204 and stage 206 provides only fit and rigging of the previously joined mesh to the avatar head and/or body.

In some implementations, the avatar may be morphed to different scales and/or further configured by a user with morphing stage 208. If implemented, the morphing stage 208 may provide a user with customization options for user selection, and automatic implementation of the selected customization options in the avatar output 265.

Hereinafter, various example components for each of the stages 202, 204, and 206 are described in detail with reference to FIGS. 2B, 2C, and 2D.

### FIG. 2B: Unconditional Model and Conditional Model

FIG. 2B is a block diagram that illustrates an example of individual components of the example pipeline of FIG. 2A, in accordance with some implementations.

In the simplified pipeline 200 of FIG. 2B, different example components are illustrated which may be implemented in stages 202, 204, and 206, according to some implementations. It is noted that according to some implementations, the entire stage 202 may be replaced with a user-selection stage where a user may select a computer-generated example image instead of providing their own images.

In an alternative example, stage 202 may include a personalization encoder 220 and a neural network 220 to generate a 2D image from images 221 provided by a user. The personalization encoder 220 may be a machine-learning model trained to output personal features of a face. For example, the personalization encoder may receive input 2D images 221 captured of the face. The input 2D images 221 may include three or more images in some implementations. In some implementations, the input 2D images may include a greater or fewer number of images. In some implementations, the input 2D images may include three images taken from a left perspective, front facing perspective, and right perspective (relatively) of the face. In some implementations, images used to train the personalization encoder 220 may also include computer-generated images from the same left, front facing, and right perspectives.

The personalization encoder 220 may be trained to output a feature vector of the features of the face. After training, the trained personalization encoder's output may be used to train a neural network 222 in operative communication with the personalization encoder 220.

The neural network 222 may include any suitable neural network that can be trained to output a 2D computer-generated image 225 of the face based upon answers to user prompts 224, an input basic 2D image 223 (e.g., a plain CG face or CG face with relatively few identifying features provided as a basic template), and/or the input images 221 encoded by the personalization encoder 220. In some implementations, the input basic 2D image 223 is a computer-generated reference image. It is noted that the input basic 2D image 223 may be omitted in some implementations and the neural network 222 may be trained to output the 2D computer-generated image 225 based on the user prompts 224 and input images 221 encoded by the personalization encoder 220. Other variations may also be applicable.

The neural network 222 may be further trained to introduce features described in the user answers/prompts 224 such that these features form at least a part of the CG image 225. For example, user prompt/answers such as “slender face, “long hair,” “big horns,” or others, may be used in 2D image generation such that the CG image includes a slender face having long hair and big horns depicted thereon. It should be readily understood that given the large number of possible user answers to prompts, that a large-language model (LLM) or other natural-language processing model may be used to identify images from a plurality of images (e.g., from an image repository of a virtual experience platform) that include such features (e.g., labeled features or self-descriptions of images). The identified images may be provided with image 223 such that the associated features are implemented in the CG image 225. Other implementations may also be applicable, such as pre-coded style vectors having those features, and omissions including those where user prompts are omitted entirely, and the output computer-generated image 225 is based on input images 221 and/or basic image 223.

The output computer-generated 2D image of the face 225 may be passed to the stage 204, for 2D to 3D generative tasks.

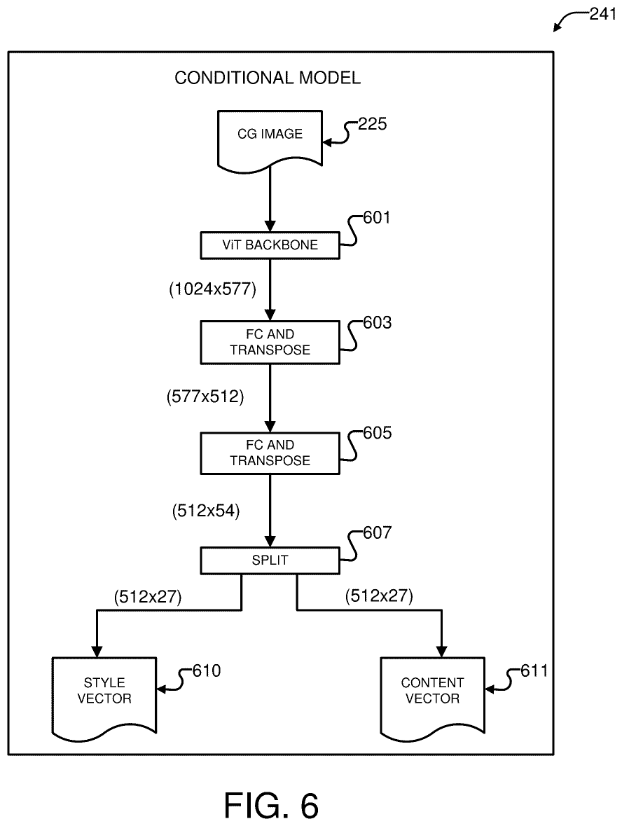

Stage 204 may include a conditional model 241 trained to output at least one feature vector that encodes features identified in the CG image 225. For example, a conditional sampling of different features may be encoded by the conditional model 241, as well as parameterization associated with an unconditional model 240. An example conditional model is illustrated in FIG. 6 and will be described in more detail below.

The unconditional model 241 may be trained to output a polygonal mesh 245 based upon the input feature vector provided by the conditional model 241 and any parameterization encoded therein. The polygonal mesh may be based upon a direct conversion of a tri-plane and/or tri-grid, in some implementations. In some implementations, the polygonal mesh 245 may be rendered by a rendering component and/or a marching cubes algorithm.

The output polygonal mesh 245 may be passed to the stage 206 for automatic placement, fitment, and rigging onto an avatar body or skeleton. For example, the output polygonal mesh 245 may be input by a topology fitting algorithm 262 to adjust the mesh for a particular avatar head topology. The topology fitting algorithm may include an operation of an autoretopology method, autoretopology algorithm, and/or autoretopology program, in some implementations. For example, the autoretopology may be based on INSTANTMESHES operations, in some implementations.

The adjusted mesh may be provided as input to a multiview texturing algorithm 264 to create a textured 3D mesh that is fit for rigging onto an avatar head data model. For example, the Multiview texturing algorithm 264 may operate to exclude certain facial features, flatten the adjusted mesh, and/or texturizing the flattened mesh.

The textured 3D mesh may then be provided as input to an automatic rigging algorithm 266 to appropriately rig the textured 3D mesh onto an avatar head as output 265. The automatic rigging algorithm 266 may reinflate the textured mesh (if not already) and automatically fit and rig the mesh onto an avatar head. Thereafter, in some implementations, the appropriately fitted and rigged avatar head may be output as output 265, or rigged onto an appropriate avatar body prior to outputting.

In some implementations, the conditional model 241 may include one or more encoders and the unconditional model may include one or more GAN generators. Hereinafter, additional example components of the stage 204 are described in detail with reference to FIGS. 2C and 2D.

### FIG. 2C: GAN Generator

FIG. 2C is a block diagram that illustrates another example of individual components of the example pipeline 200 of FIG. 2A, in accordance with some implementations. It is noted that stages 202 and 206 are illustrated here as including similar components as FIG. 2B. Therefore, superfluous description of the same components is omitted for the sake of brevity.

As illustrated, stage 204 may include a style encoder 242 configured to receive the output computer-generated 2D image of the face 225. The style encoder 242 may be trained to output a conditional density sampling of style features that are based upon the answers to user prompts 224. For example, the style encoder 242 may identify parameterization of aspects of a generative adversarial network (GAN) generator 244 such that the GAN generator 244 outputs data representing a 3D mesh useable for rigging on an avatar body.

The GAN generator 244 may include a generative adversarial network that is trained on millions of computer-generated input images such that an output 3D mesh includes personalized features from the computer-generated input images. In this manner, the GAN generator 244 may be trained to input a style feature vector from the style encoder 242, and output a 3D representation of the input 2D image 225, that includes features encoded in the style feature vector.

The GAN generator 244, based on the parameterization encoded in the style feature vector, may output data representative of a 3D mesh (e.g., such as a tri-plane or tri-grid) of the user's new avatar face. The output data may be provided as input to a multi-plane renderer 246 to create a scalar field representative of the 3D mesh. The output scalar field may be provided as input to a trained mesh generation algorithm 248 (e.g., a ray marching algorithm, renderer, or another algorithm) to output a polygonal mesh 245 of an iso-surface represented by the scalar field.

It is noted that the style encoder 242 may represent a conditional model and the GAN generator 244, rendered 246, and mesh generation algorithm 248 may represent an unconditional model. In some implementations, the unconditional model may be trained first, and then frozen for training of the conditional model. Other training methodologies may be used, in some implementations.

While the single GAN generator 244 may be satisfactory to generate high-fidelity tri-plane representations of a face depicted in CG images, some features may be difficult to customize based on single tri-plane outputs. For example, hair features in particular may be difficult to directly customize based on a single tri-plane representation. However, as described below, a dual-GAN generator can be deployed to generate two distinct tri-planes or tri-grids, each representing different portions of a face depicted in a CG image (e.g., separate hair and a bald head).

### FIG. 2D: Dual-GAN Generator

FIG. 2D is a block diagram that illustrates another example of individual components of the example pipeline of FIG. 2A, in accordance with some implementations. It is noted that stages 202 and 206 are illustrated here as including similar components as FIGS. 2B and 2C. Therefore, superfluous description of the same components is omitted for the sake of brevity.

As illustrated, stage 204 may include a style and/or content encoder 243 configured to receive the output computer-generated 2D image of the face 225. The style/content encoder 243 may be trained to output two or more vectors representing a conditional density sampling of style and content features that are based upon the answers to user prompts 224 and the input CG image 225. For example, the style/content encoder 243 may also identify parameterization of aspects of a dual-GAN generator 271 such that the dual-GAN generator 271 outputs data representing a 3D mesh useable for rigging on an avatar body. For example, the dual-GAN generator 271 may be arranged as two GAN-based networks in communication with a single discriminator configured to receive outputs from each GAN-based network of the two GAN-based networks, in some implementations.

The two or more feature vectors output by the style/content encoder 243 may separately represent features of the CG image 225 such as hair and head. In this manner, different representations of the CG image may be separately processed to create dual polygonal meshes 246. In one implementation, a first of the two or more feature vectors is input into a first GAN-generator of the dual-GAN generator 271 and a second of the two or more feature vectors is input into a second GAN-generator of the dual-GAN generator 271.

The dual-GAN generator 271 is trained to input two distinct feature vectors output by the style/content encoder 242, and output two distinct data representations or data structures that are directly convertible into separate 3D meshes. In one implementation, the two distinct data structures include tri-planes or tri-grids. In one implementation, a first of the two distinct data structures represents a bald head based on a face contained in the CG image 225; and a second of the two distinct data structures represents hair based on a face contained in the CG image 225. As such, both a bald and head with hair avatar may be created by stage 204, in some implementations.

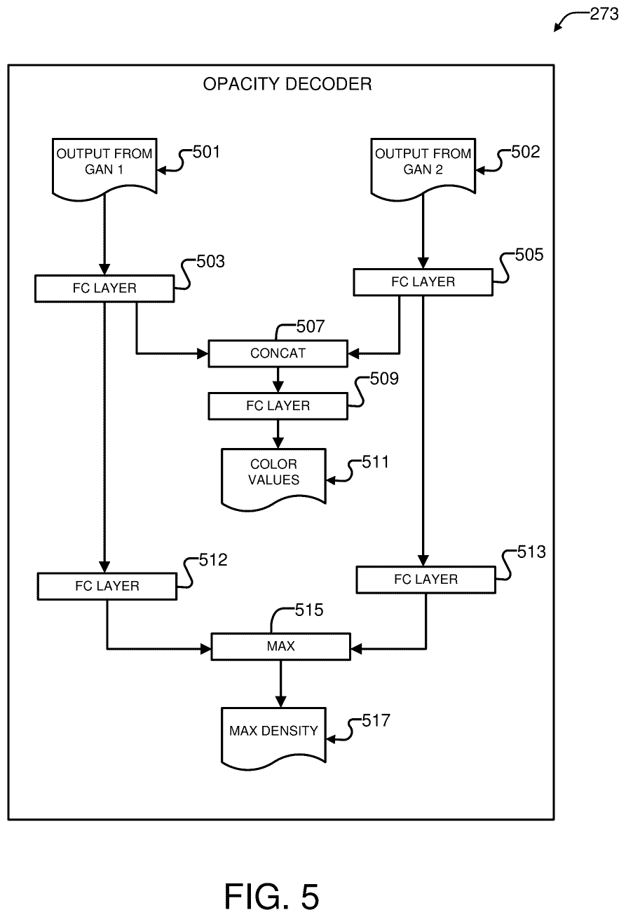

The data structures output by the dual-GAN generator 271 may be input by an opacity decoder 273. The opacity decoder 273 may be configured to output both a set of color values and a set of densities for each location in a volume of each of the distinct data structures output by the dual-GAN generator. An example opacity decoder is illustrated in FIG. 5 and will be described in more detail below.

The opacity decoder 273 may provide outputs to both of a low-resolution network and a high-resolution network, to produce both high- and low-resolution image outputs. For example, a ray marching algorithm 248 may represent a low-resolution network configured to output low-resolution images. In some implementations, the ray marching algorithm 248 outputs low-resolution images representing a bald head only. Furthermore, for example, the differential renderer 275 and super resolution neural network 277 may represent a high-resolution network configured to output high-resolution images. In one implementation, the combination of the differential renderer 275 and super resolution neural network 277 output high-resolution images of hair. In some implementations, the feature vector containing encoded hair features is also directly input by the super resolution neural network 277.

Both the high- and low-resolution output images are assembled into polygonal meshes such that dual polygonal meshes 246 are output by the stage 204. One or both of the dual polygonal meshes may be assembled by the stage 206 to create either a bald head avatar or a non-bald head avatar (e.g., by placing the hair mesh onto the bald head mesh) as output 265. It is noted that while two polygonal meshes are produced, only a single avatar is output in this example. In other implementations, both a bald and a non-bald head avatar may also be output. Other variations, including separation of other features into distinct tri-planes and tri-grids may also be applicable, depending upon the parameterization and training of the dual-GAN generator 271.

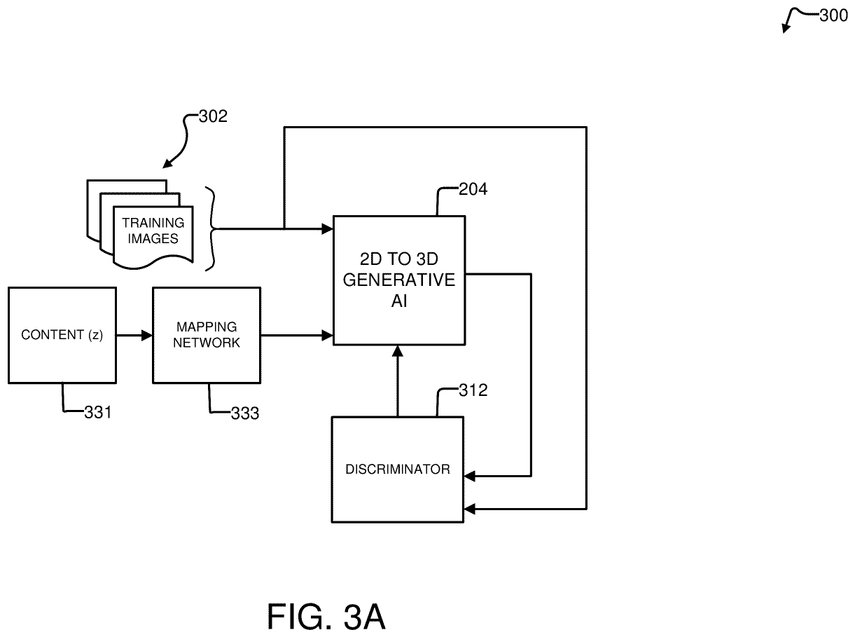

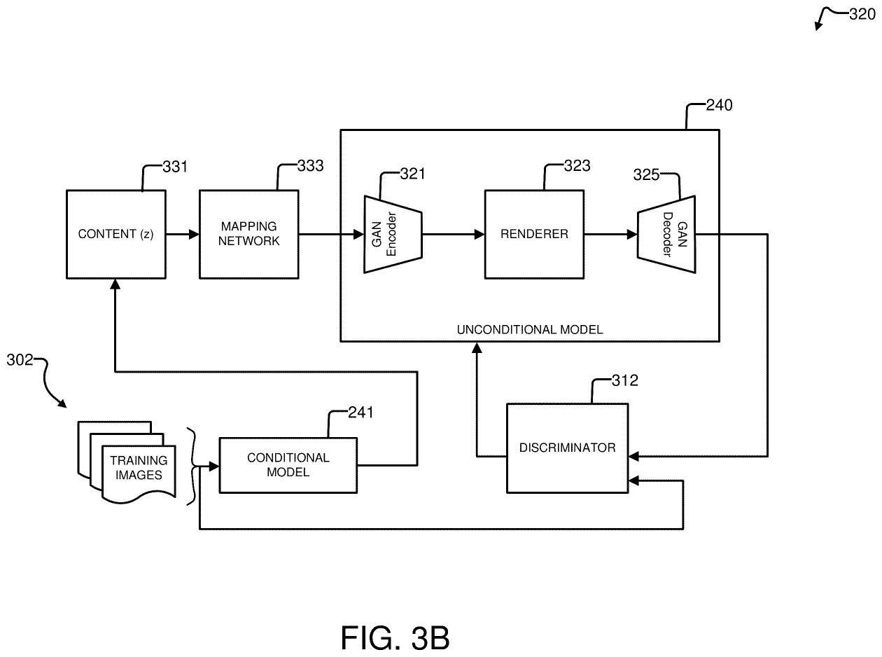

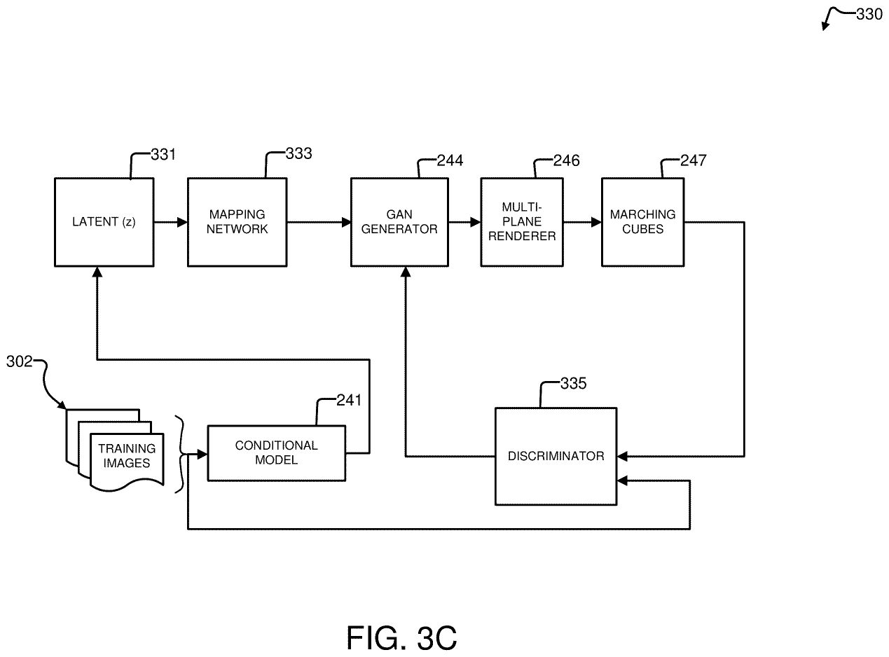

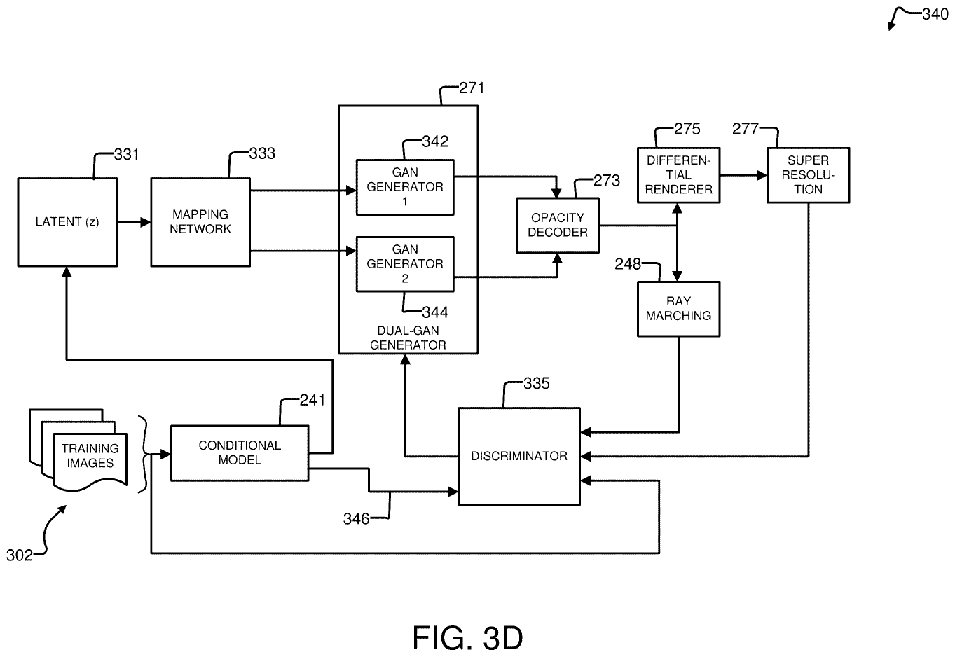

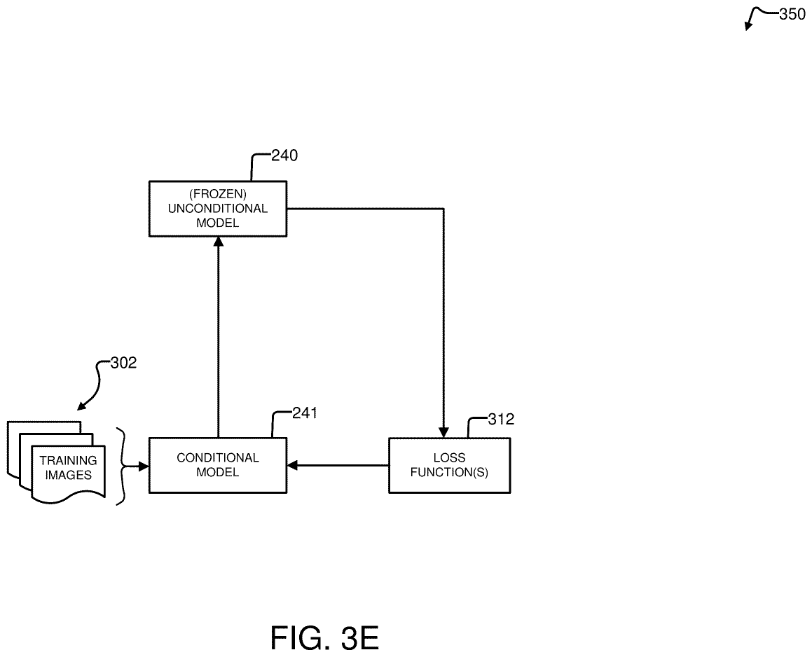

Hereinafter, training methodologies and architectures for training of the individual components of the 2D to 3D stage 204 are described in detail, with reference to FIG. 3A-3E.

### FIG. 3A: Basic Training Architecture

FIG. 3A is a block diagram that illustrates an example training architecture of the example pipeline of FIG. 2A, in accordance with some implementations. As illustrated in FIG. 3A, a training architecture 300 may include a 2D to 3D generative AI stage 204 (object of training), as well as a discriminator 312 in operative communication with stage 204, content latent 331, mapping network 333 in operative communication with the content latent 331 and stage 204, and a plurality of training images 302 provided to stage 204 during training.

In one implementation, stage 204 receives as input the plurality of training images 302. An output data structure representative of a face depicted in a training image from the plurality, is generated by the stage 204 and provided to the discriminator 312. The output data structure is based upon the training image and a style latent output by the mapping network 333. The style latent is based upon content latent 331 which may also include noise, in some implementations. The style latent is configured to capture style details and improve style quality of outputs.

The discriminator 312 is configured to compare the output data structure from stage 204 to the input training image, and output a Boolean value. The Boolean value is based on a determination by the discriminator 312 that the output data value represents a “true” representation of the input image, or a “false” representation of the input image. If the Boolean value is “true,” then adjustments are made to the discriminator 312 to improve discrimination between the provided outputs and the training images. If the Boolean value is “false,” then adjustments are made to the stage 204 to improve aspects of the output data structures to better represent the input image and/or to more accurately depict features of the input image.

Training of the stage 204 may be repeated for a large number (e.g., millions) of training images 302 and over one or more training epochs. Training may end when a particular number of training epochs have been concluded, in some implementations. In some implementations, training may end when convergence is anticipated or predicted for the stage 204. It is noted that under some circumstances it may be difficult to ascertain convergence, and anticipation or prediction of convergence may be based upon calculation of discriminator outputs approaching 50%. In some implementations, training may end when a sampling window of discriminator outputs average near 50%. This may improve a probability that the stage 204 is not training on randomly chosen discriminator outputs (e.g., when the discriminator in effect “flips a coin” for its Boolean output.

Hereinafter, training of an unconditional model having a defined generative-adversarial network is described in detail, with reference to FIG. 3B.

### FIG. 3B: Training Architecture of Unconditional Model

FIG. 3B is a block diagram that illustrates an example training architecture of the example components of FIG. 2B, in accordance with some implementations. As illustrated in FIG. 3B, a training architecture 320 may include an unconditional model 240 (object of training), as well as a discriminator 312 in operative communication with model 240, content latent 331, mapping network 333 in operative communication with the content latent 331 and model 240, and a plurality of training images 302 provided to a conditional model 241 during training.

In some implementations, conditional model 241 receives as input the plurality of training images 302. The conditional model 241 may be configured to provide style vectors based upon the training images 302 to the mapping network 333. The mapping network 331 may receive content latent 331. The mapping network 333 may generate a style latent. For example, the content latent 331 may include noise, in some implementations.

The mapping network 331 provides the style latent and style vectors to a GAN encoder 321 of the model 240. Output of the GAN encoder 321 is provided to a rendered 323, and the rendered output of the rendered 323 is provided to a GAN decoder 325 of the model 240.

An output data structure representative of a face depicted in a training image from the plurality, is generated by the GAN decoder 325 and provided to the discriminator 312. The output data structure is based upon the style vector and style latent output by the mapping network 333.

The discriminator 312 is configured to compare the output data structure from model 240 to the input training image, and output a Boolean value. The Boolean value is based on a determination by the discriminator 312 that the output data structure represents a “true” representation of the input image, or a “false” representation of the input image. If the Boolean value is “true,” then adjustments are made to the discriminator 312 to improve discrimination between the provided outputs and the training images. If the Boolean value is “false,” then adjustments are made to the model 240 (e.g., adjustments to the encoder 321 and/or decoder 325) to improve aspects of the output data structures to better represent the input image and/or to more accurately depict features of the input image.

Training of the model 240 may be repeated for millions of training images 302 and over one or more training epochs. Training may end when a particular number of training epochs have been concluded, in some implementations. In some implementations, training may end when convergence is anticipated or predicted for the model 240. It is noted that under some circumstances it may be difficult to ascertain convergence, and anticipation or prediction of convergence may be based upon calculation of discriminator outputs approaching 50%. In some implementations, training may end when a sampling window of discriminator outputs average near 50%. This may improve a probability that the stage 204 is not training on randomly chosen discriminator outputs (e.g., when the discriminator in effect “flips a coin” for its Boolean output.

Hereinafter, training of a GAN generator as arranged in FIG. 2C is described in detail with reference to FIG. 3C.

### FIG. 3C: Training Architecture of GAN Generator

FIG. 3C is a block diagram that illustrates an example training architecture of the example components of FIG. 2C, in accordance with some implementations. As illustrated in FIG. 3C, a training architecture 330 may include a GAN generator 244 (object of training), a multi-plane renderer 246, and a marching cubes algorithm 247. The architecture 330 further includes a discriminator 335 in operative communication with the GAN generator 244. The architecture 330 also includes content latent 331, mapping network 333 in operative communication with the content latent 331 and GAN generator 244, and a plurality of training images 302 provided to conditional model 241 during training.

In some implementations, conditional model 241 receives as input the plurality of training images 302. The conditional model 241 may be configured to provide style vectors based upon the training images 302 to the mapping network 333. The mapping network 331 may receive content latent 331. The mapping network 333 may generate a style latent. For example, the content latent 331 may include noise, in some implementations.

The mapping network 331 provides the style latent and style vectors to the GAN generator 244. The GAN generator 244 generates an output data structure representative of a face depicted in a training image from the plurality. The multi-plane renderer 246 receives the output data structure and creates a scalar field (e.g., through ray-marching or other methodologies) representative of a 3D mesh. The multi-plane renderer 246 may also include a multi-layer perceptron layer to additionally output a color value and density, in some implementations. The output scalar field, along with color and density values, may be provided as input to the marching cubes algorithm 247 (or another rendering algorithm such as a ray marching algorithm) to output a polygonal mesh of an iso-surface represented by the scalar field.

The discriminator 335 is configured to compare the output polygonal mesh to the input training image, and output a Boolean value. The Boolean value is based on a determination by the discriminator 335 that the polygonal mesh includes a “true” representation of the input image, or a “false” representation of the input image. If the Boolean value is “true,” then adjustments are made to the discriminator 335 to improve discrimination between the provided outputs and the training images. If the Boolean value is “false,” then adjustments are made to the GAN generator 244 to improve aspects of the output data structures, used to create the polygonal mesh, to better represent the input image and/or to more accurately depict features of the input image.

Training of the GAN generator 244 may be repeated for a large number (e.g., millions) of training images 302 and over one or more training epochs. Training may end when a particular number of training epochs have been concluded, in some implementations. In some implementations, training may end when convergence is anticipated or predicted for the GAN generator 244. It is noted that under some circumstances it may be difficult to ascertain convergence, and anticipation or prediction of convergence may be based upon calculation of discriminator outputs approaching 50%. In some implementations, training may end when a sampling window of discriminator outputs average near 50%. This may improve a probability that the GAN generator 244 is not training on randomly chosen discriminator outputs (e.g., when the discriminator in effect “flips a coin” for its Boolean output.

Hereinafter, training of a dual-GAN generator is described in detail with reference to FIG. 3D.

### FIG. 3D: Training Architecture of Dual-GAN Generator

FIG. 3D is a block diagram that illustrates an example training architecture of the example components of FIG. 2D, in accordance with some implementations. As illustrated in FIG. 3D, a training architecture 340 may include a dual-GAN generator 271 (object of training), opacity decoder 273, differential renderer 275, super resolution neural network 277, and ray marching algorithm 248. The architecture 340 may also include discriminator 335 in operative communication with the dual-GAN generator 271, content latent 331, mapping network 333 in operative communication with the content latent 331 and dual-GAN generator 271, and a plurality of training images 302 provided to conditional model 241 during training.

In some implementations, conditional model 241 receives as input the plurality of training images 302. The conditional model 241 may be configured to provide style and content vectors based upon the training images 302 to the mapping network 333. The mapping network 333 may generate a style latent vector and a content latent vector, based upon the content latent 331. For example, the content latent 331 may include noise, in some implementations.

In some implementations, the mapping network 333 may include Kullback-Leibler divergence-based regularization (KLD regularization), to improve disentanglement between hair and head. For example, a variational auto-encoder (VAE) may be implemented in the mapping network 333 such that instead of directly outputting the content vector and style vector, mean and variance vectors are learned, which are then used to sample style and content vectors. Thereafter, the sampled style and content vectors are used in training (e.g., to improve spatial embeddings). This approach improves disentanglement and output quality during training of the dual-GAN generator 271.

Additionally, due to condition dropping, the style vector remains independent of camera parameters associated with the training input images. Instead, a null embedding of the camera parameter is learnt, which may then be used by renderers and during inference. Additionally, to improve parameter conditioning, noisy and quantized camera parameter conditions may be implemented in the mapping network 333.

For example, extreme camera angles for training images may be quantized to avoid inaccuracy with regard to these extreme angles. According to some implementations, camera angles can vary such as: yaw may vary from [−120 deg; 120 deg], pitch may vary from [−30 deg; 30 deg]. Other modifications and/or augmentations to camera parameters associated with training images may be applicable.

The mapping network 331 provides the style latent, content latent, sampled content vectors, and sampled style vectors to the dual-GAN generator 271. The dual-GAN generator 271 includes a first GAN generator 342 and a second GAN generator 344. As two GAN generators are under training and aim to produce distinct outputs that represent both a bald head and hair, several improvements over training methodologies associated with single GAN generators are implemented.

The first GAN generator 342 may be configured as a full head tri-plane generator, G₀, configured to produce a bald head tri-plane P₀. The first GAN generator 342 is conditioned during training with a full head style vector

$${ω}_{s}^{0} .$$

The second GAN generator 344 may be configured as a hair tri-plane generator, G₁, configured to produce a hair tri-plane P₁. The second GAN generator 344 is conditioned during training with a concatenation of a head and hair style vector

$${ω}_{s}^{1} .$$

The head and hair style vector

$${ω}_{s}^{0}$$

may produce outputs that allow both head and hair to match up properly for downstream processing (e.g., to assemble the two eventual meshes with little difficulty).

An additional “no hair” embedding @null may be learned, which represents a lack of hair

$$( i . e . , when {ω}_{s}^{1} = {ω}_{n u l l} ) .$$

Accordingly, the dual-GAN generator 271 may be represented by Equation 1, below:

$${P}_{0} = {G}_{0} ( {θ}_{{G}_{0}} , {ω}_{s}^{0} ) , {P}_{1} = {G}_{1} ( {θ}_{{G}_{1}} , ( {ω}_{s}^{0} , {ω}_{s}^{1} ) ) \qquad Equation l$$

In Equation 1, G₀ and G₁ share the same architecture except for an extra input layer configured to handle the

$$( {ω}_{s}^{0} , {ω}_{s}^{1} )$$

dimension in G₁. It is noted that the head vector

$${{ω}_{s}^{0}}^{}$$

is also led into G₁ along with

$${ω}_{s}^{1} ,$$

enabling G₁ to be aware or head geometry so that the generated hair tri-plane P₁ matches the bald head P₀.

Each plane of the produced tri-planes includes a channel dimension of 32, which is passed to opacity decoder 273. Opacity decoder 273 may be formed as a multi-layer perceptron, in some implementations. Opacity decoder 273 is configured to output both color and density data (e.g., RGB and σ) of the composition of head and hair at each voxel location of the associated tri-planes.

The opacity decoder 273, for hair, implements a maximum function over multiple density candidates from the tri-plane representing hair (e.g., see FIG. 5). For color data, the opacity decoder 273 implements a concatenation of all outputs from each tri-plane (e.g., or from both tri-planes) which are fed into a fully-connected layer, resulting in a dimension of 32 for color data.

Outputs from the opacity decoder 273 are fed into differential renderer 275 (for high-resolution images) and into ray marching algorithm 248 (for low-resolution images). The low-resolution output takes a condition defined by the sampled style vector of the head only (e.g., not the hair). This condition may be injected through modulated convolution.

The high-resolution output is first processed by the differential renderer 275. Optionally, the differential renderer 275 may also receive camera angle data associated with the input images, such that orientation of the output of the renderer 275 matches that of the input images. However, it is noted that the camera parameter is not used during inference, as a learnt null embedding is instead used in lieu of camera parameters at inference.

The output from the differential renderer 275 is received by the super-resolution neural network 277. The super-resolution neural network 277 takes a concatenation of the sampled style vectors of both the head and the hair. This condition may be injected through use of arbitrary style transfer.

Outputs of both of the ray marching algorithm 248 and the super-resolution neural network 277 are fed into the discriminator 335. The discriminator 335 may also receive a Boolean signal “is-bald” represented by signal 346. Furthermore, the discriminator 335 may receive randomly “dropped” camera parameters to avoid the discriminator 335 associating fake images with camera parameters. As such, a null embedding is learnt which is used in lieu of camera parameters at inference time. Furthermore, in some implementations, Gaussian noise (or other suitable noise) may be added to camera parameters, in addition to randomly dropped camera parameters, to help ensure the discriminator has no manner of associating camera parameters to input samples. Through these features, a single discriminator 335 may be used for training of both the first and second GAN generators 342, 344 while being able to discriminate correctly between outputs of only hair as well as outputs of bald heads. Furthermore, to enforce disentanglement between bald heads and hair, a regularization loss may be added on the hair tri-plane output from the second GAN generator 344, such that it converges on null content.

The discriminator 335 is configured to compare the output polygonal meshes (both bald heads and hair) to the input training image, and output a Boolean value. The Boolean value is based on a determination by the discriminator 335 that the selected polygonal mesh includes a “true” representation of the input image, with hair or without, or a “false” representation of the input image. If the Boolean value is “true,” then adjustments are made to the discriminator 335 to improve discrimination between the provided outputs and the training images. If the Boolean value is “false,” then adjustments are made to the dual-GAN generator 271 to improve aspects of the output data structures, used to create the polygonal meshes, to better represent the input image and/or to more accurately depict features of the input image.

It is noted that several implementation choices may be made to control output quality, including avoiding hue shift between bald heads and hair, thereby improving computational efficiency and reducing visual distinctions between the hair tri-plane and the bald head tri-place. For example, the low-resolution network (e.g., the marching cubes 248) receives the condition of bald head tri-plane only. Additionally, the condition to the super-resolution neural network 277 is the head and hair style and content vectors. Furthermore, the discriminator 335 is passed both the low-resolution and high-resolution outputs (e.g., to prevent different colors between high- and low-resolution outputs). Furthermore, when extracting density, RGB and/or color content may be nulled out under some circumstances such that disentanglement of head and hair tri-planes. Furthermore, the opacity decoder 273 implements a fully connected layer with no bias, so that no hair color information leaks into final color information for the bald head. These and other modifications may be appropriate for any implementation.

Training of the dual-GAN generator 271 may be repeated for a large number (e.g., millions) of training images 302 and over one or more training epochs. Training may end when a particular number of training epochs have been concluded, in some implementations. In some implementations, training may end when convergence is anticipated or predicted for the dual-GAN generator 271 while also having properly disentangled hair and head tri-planes. It is noted that under some circumstances it may be difficult to ascertain convergence, and anticipation or prediction of convergence may be based upon calculation of discriminator outputs approaching 50%. In some implementations, training may end when a sampling window of discriminator outputs average near 50%. This may improve a probability that the dual-GAN generator 271 is not training on randomly chosen discriminator outputs (e.g., when the discriminator in effect “flips a coin” for its Boolean output.

Upon training of unconditional models, including a GAN generator or dual-GAN generator, the unconditional model may be frozen such that training of the conditional model may commence. Hereinafter, training of a conditional model is described more fully with reference to FIG. 3E.

### FIG. 3E: Training Architecture of Conditional Model

FIG. 3E is a block diagram that illustrates an example training architecture of a conditional model, in accordance with some implementations. As illustrated, a frozen unconditional model 240 is in operative communication with a conditional model 241 and one or more loss functions 312.

The frozen unconditional model 240 may include any of the example unconditional models provided above, including GAN-based models, single GAN-generators, and/or dual-GAN generators. Furthermore, the conditional model 241 may include any of the example conditional models provided above, including style encoders, style/content encoders, and others. An additional example conditional encoder is provided with reference to FIG. 6, and is described more fully below.

The conditional model is trained by inputting a sequence of training images 302. The conditional model 241 produces, as output in response to each training image, at least one feature vector. The at least one feature vector is received by the frozen unconditional model 240.

Based upon the output of the frozen unconditional model 240, one or more losses may be calculated by loss functions 312. Based upon the losses calculated, adjustments are made to the conditional model 241 and training is repeated on a new training image from the plurality.

Multiple losses may be implemented at loss functions 312, to improve training and functionality of the conditional model 241. For example, appropriate losses may include L1-smooth losses, identity losses, Learned Perceptual Image Patch Similarity (LPIPS) losses, and/or others.

In some implementations, a reconstruction L1-smooth loss of input image versus generated super-resolution neural network output is implemented.

In some implementations, a reconstruction L1-smooth loss of downscaled input image versus low-resolution output (e.g., from a marching cubes algorithm) is implemented. It is noted that this L1-smooth loss may help further ensure that colors do not diverge between the low- and high-resolution outputs.

In some implementations, an identity loss is implemented with a facial recognition algorithm or trained facial recognition model.

In some implementations, an LPIPS loss on input image versus generated bold head super-resolution output is implemented. For this loss, a ray marching algorithm may be executed over half of a depth to receive hair segmentation and weigh the loss according to a hair mask. Such a loss calculation allows detail matching on a head with hair versus a bald head, based on the same training image.

In some implementations, an LPIPS loss on input image versus generated super-resolution neural network output is implemented.

In some implementations, GAN loss on an input image versus generated super-resolution neural network output is implemented. This loss may avoid the generated of “flat heads” or distortions to a scalp portion of produced bald heads.

Training may be implemented in architecture 350 until a threshold number of individual training cycles are completed, until a particular number of training epochs based on different sets of training images are completed, until losses are reduced below a threshold value, and/or until losses are minimized, in some implementations.

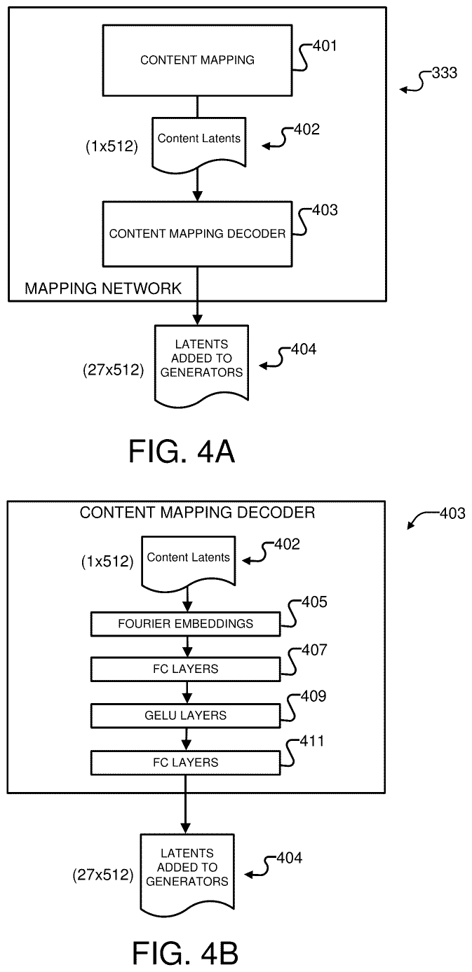

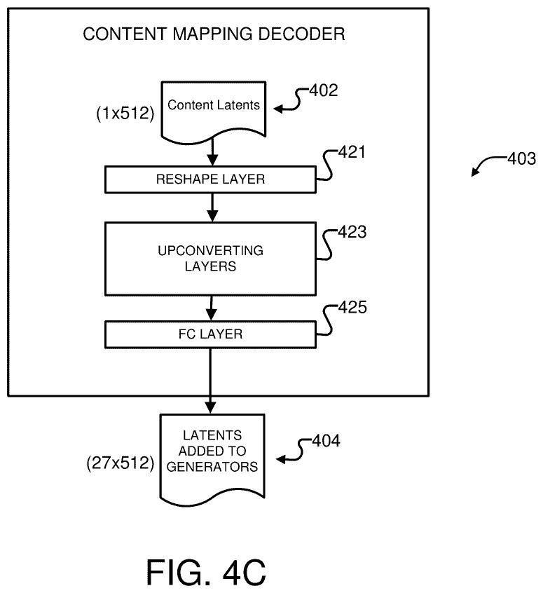

As described above, unconditional model training may occur prior to conditional model training. Furthermore, in training of some unconditional models, a mapping network may be used (with or without VAE) to provide feature vectors to a GAN generator or dual-GAN generator in training. Hereinafter, an example of an appropriate mapping network as well as example mapping decoders are described more fully with reference to FIGS. 4A-4C.

### FIG. 4: Content Mapping

FIG. 4A is a block diagram of a mapping network 333, in accordance with some implementations. As illustrated, the mapping network 333 may include a content mapping network 401 configured to output content latents vector 402. The mapping network 33 may also include a content mapping decoder 403 configured to receive the content latents vector 402 and produce an output of latents to be added to GAN generators under training, denoted as 404.

It is noted that in conventional GAN generators configured to produce 3D meshes, there is an existing drawback that details such as animal horns, animal ears, robotic features, and other non-human features are often difficult to capture. However, as shown in FIGS. 4B and 4C, the content latents 402 may be decoded such that spatial details are more accurately and effectively captured. In this manner, the latents 404 added to the GAN generators under training, are more likely to accurately reproduce features that may not be associated with an average human face, thereby improving the accuracy of many different types of faces for use in avatar creation.

FIG. 4B is a block diagram of an example content mapping decoder 403 of the mapping network of FIG. 4A, in accordance with some implementations. As shown, in this implementation, the content mapping decoder 403 is arranged as a multi-layer perceptron with Fourier features. For example, content latents vector 402 is decoded through layers 405, 407, 409, and 411.

For example, initially the content latents vector 402 is converted with Fourier embeddings 405 to Fourier features. This allows capture of high frequency information about mesh and texture. Thereafter, the Fourier features are decoded by a fully connected layer 407 and a Gaussian error linear unit 409, before a last fully connected layer 411 maps the output of the GELU layer 409 to the proper spatial resolution of the intended GAN generator block.

It is noted that portions of each of layers 405, 407, 409, and 411 may be split into two separate decoder networks, operating in parallel, according to some implementations. In these implementations, separate outputs from different GELU layers may provide latents 404 for distinct GAN generators of a dual-GAN generator.

Alternatively, a deep content decoder network may be implemented, as shown in FIG. 4C.

FIG. 4C is a block diagram of another example content mapping decoder 403 of the mapping network of FIG. 4A, in accordance with some implementations. As shown, the content mapping decoder 403 may also be implemented with a reshape layer 421, upconverting layers 423, and a fully connected layer 425, to produce latents 404.

For example, the reshape layer 421 may reshape content latents vector 402 into latent embeddings of a defined spatial dimension. This may further include a single N-layer convolutional network as a decoder for the content latent embeddings to be upconverted.

Thereafter, a sequence of upconverting layers 423 gradually decode the content latent embeddings until a final fully connected layer 425 outputs the latents 404. In some implementations, a convolutional neural network architecture is used for layers 421, 423, and 425.

It is noted that portions of each of layers 421, 423, and 425 may be split into two separate decoder networks, operating in parallel, according to some implementations. In these implementations, separate outputs from layers may provide latents 404 for distinct GAN generators of a dual-GAN generator.

As described above, during training, a dual-GAN generator may output two distinct tri-planes. The distinct tri-planes may be fed into an opacity decoder such that density and color data is provided for rendering both high- and low-resolution outputs. Hereinafter, an example opacity decoder useable to extract color and density data from tri-planes output by a dual-GAN generator is described in detail with reference to FIG. 5.

### FIG. 5: Example Opacity Decoder

FIG. 5 is a block diagram of an example opacity decoder 273, in accordance with some implementations. As illustrated, the opacity decoder 273 may receive as input, outputs provided by a dual-GAN generator. For example, an output 501 from a first GAN generator and an output 502 from a second GAN generator may be input by the opacity decoder 273.

During operation, and for each location in a volume of a tri-plane being processed, the opacity decoder samples features which are input into fully connected layers. For example, two fully connected layers 503, 505 separately receive respective outputs 501, 502. The fully connected layers 503, 505 separate the outputs 501, 502 into chunks such that first respective chunk is transmitted to fully connected layers 512, 513; and a second respective chunk is transmitted to concatenation 507 to be joined. The joined features are provided to fully connected layer 509 where color values 511 are extracted.

Fully connected layers 512, 513 operate to extract density information, and a maximum function 515 operates to provide the maximum extracted density 517 as output.

It is noted that the example opacity decoder shown in FIG. 5 may be implemented with a dual-GAN generator such as dual-GAN generator 271.

As described above, a conditional model may be implemented to provide feature vectors to GAN generators, according to some implementations. In some implementations, a style encoder and/or a style/content encoder may be used as a conditional model. In some implementations, other conditional models may be appropriate. For example, a conditional model based upon a vision transformer is described in detail with reference to FIG. 6.

### FIG. 6: Example Conditional Model

FIG. 6 is a block diagram of an example conditional model 241, in accordance with some implementations. As illustrated, the conditional model 241 may include a vision transformer (ViT) backbone 601 configured to receive a CG image 225. The ViT backbone 601 may have all pooling layers removed to preserve high frequency information. Furthermore, it is noted that as arranged in FIG. 6, the ViT backbone 601 ensures regression of both the style vector and the content vector using the same transformer (e.g., two different types of vectors are regressed in conditional inference). The ViT backbone 601 is configured to generate an embedding sequence with dimensions (1024×577) from the image 225.

Thereafter, a first fully connected and transpose layer 603 receives the embedding sequence. The embedding sequence is processed by the fully connected layer and transposed, resulting in an output of dimensions (577×512).

The transformed embedding is further processed by a second fully connected and transpose layer 605. The transformed embedding sequence is processed by the fully connected layer and transposed, resulting in an output of dimensions (512×54).

Finally, the output from layer 605 is split by split layer 607 into separate style and content vectors 610 and 611, respectively. It is noted that style and content vectors 610, 611 may also be referred to as “first and second style vectors,” “first and second feature vectors,” and similar terms, without departing from the scope of this disclosure.

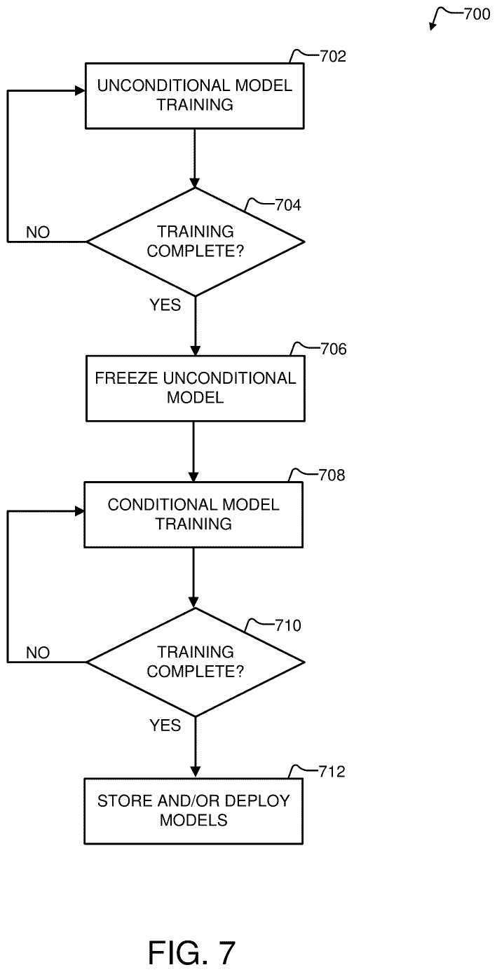

As presented in detail above, individual example components useable together in different implementations of a 2D to 3D generative stage 204, of the generative pipeline 200, have been described in detail. Furthermore, individual training architectures for different components have been illustrated and described in detail above. Hereinafter, methods of training are presented with reference to FIGS. 7-9.

### FIGS. 7-9: Methods of Training

FIG. 7 is a flowchart of an example method 700 to train the example generative pipeline of FIG. 2A, in accordance with some implementations. In some implementations, method 700 can be implemented, for example, on a server system, e.g., online virtual experience platform 102 as shown in FIG. 1 and/or according to the training architectures presented above. In some implementations, some or all of the method 700 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 700.

The method 700 commences at block 702. Block 702 includes training an unconditional model. For example, the training may include training of the unconditional model as described in detail with reference to FIGS. 3A, 3B, 3C, and 3D. The training may include at least one training epoch and/or training based on a set of training images. Block 702 is followed by block 704.

At block 704, it is determined whether training of the unconditional model is complete. If training of the conditional model is complete, block 704 is followed by block 706; else, block 704 is followed by block 702 where training continues.

At block 706, parameters of the unconditional model are frozen. Block 706 is followed by block 708.

At block 708, training of the conditional model is performed. For example, the training may include training of the conditional model as described in detail above with reference to FIG. 3E. Block 708 is followed by block 710.

At block 710, it is determined whether training of the conditional model is complete. The training may include training until a loss function or functions are minimized and/or other training thresholds are met. If training of the conditional model is complete, block 710 is followed by block 712; else, block 710 is followed by block 708 where training continues.

At block 712, with both of the unconditional model and the conditional model trained, the models may be stored and/or deployed at, for example, a virtual experience platform 102 and/or system 100. Other platforms and systems may also deploy the conditional and unconditional models to provide fully animatable avatars therefrom.

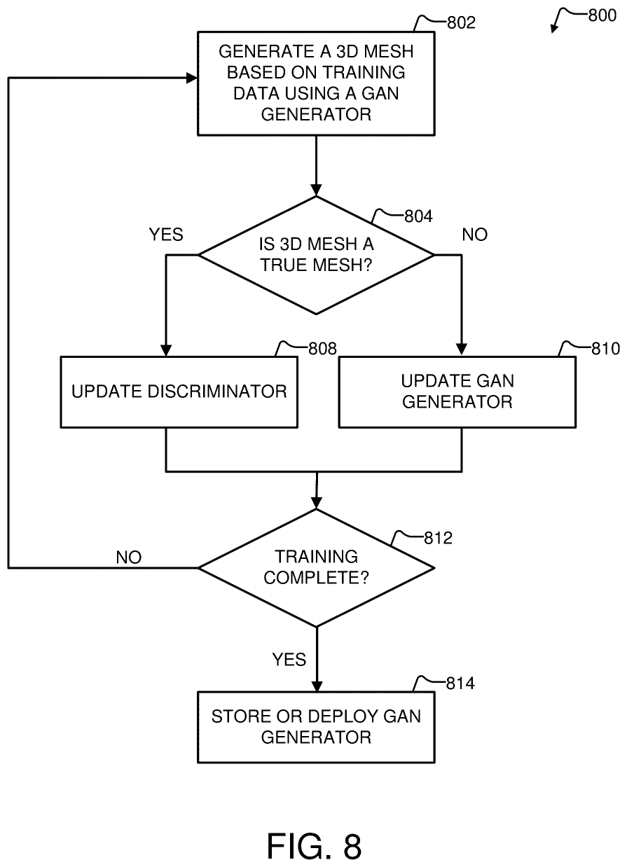

In some implementations, such as the example illustrated in FIG. 2C and FIG. 3C, a GAN-generator may be deployed in an unconditional model. FIG. 8 is a flowchart of an example method 800 to train an unconditional model having a GAN generator, in accordance with some implementations. In some implementations, method 800 can be implemented, for example, on a server system, e.g., online virtual experience platform 102 as shown in FIG. 1 and/or according to the training architectures presented above. In some implementations, some or all of the method 800 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 800.

The method 800 commences at block 802. At block 802, a 3D mesh is generated based on training data, and by a GAN generator. For example, GAN generator 244 may produce a tri-plane which is converted into an appropriate 3D mesh. Block 802 is followed by block 804.

At block 804, it is determined whether the generated 3D mesh is a valid representation of the training data, by a discriminator. For example, discriminator 335 may provide a Boolean output with the determination of block 804. If the output is true or yes, block 804 is followed by block 808. If the output is false or no, block 804 is followed by block 810.

At block 808, the discriminator is updated to improve discrimination between generated 3D meshes and the training data. While at block 810, the GAN generator is updated to improve outputs to fool the discriminator. Both of blocks 808 and 810 are followed by block 812.

At block 812, it is determined if training is completed. For example, training may be stopped if a threshold number of training images have been processed, if a particular number of training epochs have been completed, and/or by consideration of whether the GAN generator has converged. If training is complete, block 812 is followed by block 814; else, block 812 is followed by block 802 where training continues with generation of an additional 3D mesh.

At block 814, the trained GAN generator may be stored and/or deployed for use.

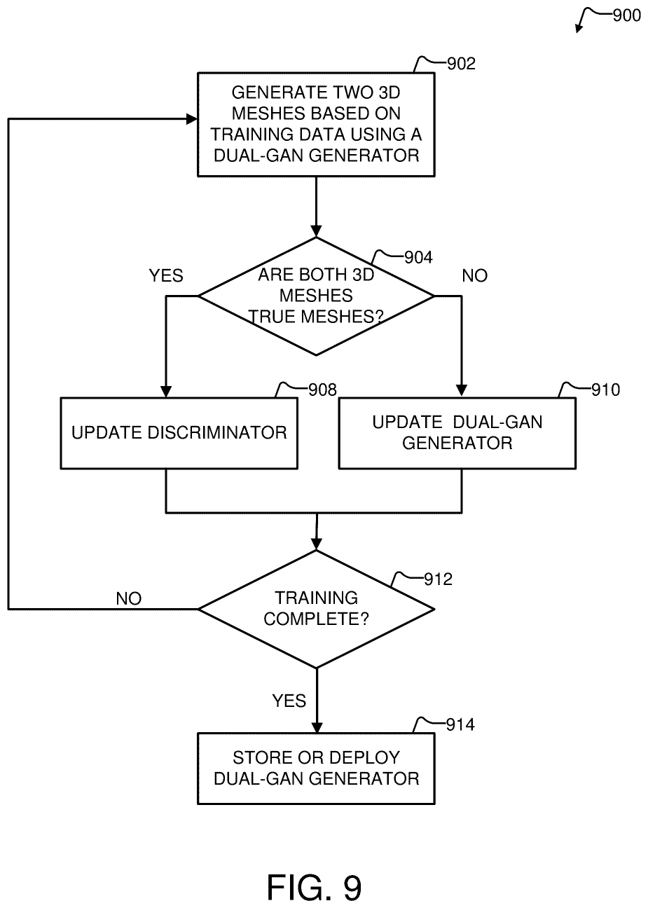

As described above, training of a GAN generator may leverage a discriminator to converge the GAN generator during training. In an examples where a dual-GAN generator is to be trained, a single discriminator may also be used. Hereinafter, a method of training a dual-GAN generator with a single discriminator is described with reference to FIG. 9.

FIG. 9 is a flowchart of an example method 900 to train an unconditional model having a dual-GAN generator, in accordance with some implementations. In some implementations, method 900 can be implemented, for example, on a server system, e.g., online virtual experience platform 102 as shown in FIG. 1 and/or according to the training architectures presented above. In some implementations, some or all of the method 900 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 900.

The method 900 commences at block 902. At block 902, two 3D meshes are generated based on training data, and by a dual-GAN generator. For example, dual-GAN generator 271 may produce two distinct tri-planes, which are converted into respective 3D meshes. Block 902 is followed by block 904.

At block 904, it is determined whether the generated 3D meshes are both valid representations of the training data, by a single discriminator. For example, discriminator 335 may be arranged to compare both bald heads and heads with hair, as described in detail above. Use of a single discriminator may provide advantages including better disentangled outputs from each GAN generator, among others.

In this example, discriminator 335 may provide a Boolean output with the determination of block 904, based on both generated 3D meshes. When determining whether a head with hair is being determined, the discriminator 335 may operate as described above with reference to FIG. 8. When determining if a bald head is being determined, a signal 346 may be passed to the discriminator 335 such that an appropriate determination between bald features is executed. If the output is true or yes, block 904 is followed by block 908. If the output is false or no, block 904 is followed by block 910.

At block 908, the discriminator is updated to improve discrimination between generated 3D meshes and the training data. While at block 910, the dual-GAN generator is updated to improve outputs to fool the discriminator. Both of blocks 908 and 910 are followed by block 912.

At block 912, it is determined if training is completed. For example, training may be stopped if a threshold number of training images have been processed, if a particular number of training epochs have been completed, and/or by consideration of whether the dual-GAN generator has converged and includes an appropriate disentanglement between heads with hair and bald heads. If training is complete, block 912 is followed by block 914; else, block 92 is followed by block 902 where training continues with generation of an additional 3D mesh.

At block 914, the trained dual-GAN generator may be stored and/or deployed for use.

Deployed GAN generators, such as GAN generator 244 and dual-GAN generator 271, may be used for automatically generating avatars. Hereinafter, a more detailed discussion of automatically generating avatars using the trained models described above, is presented below.

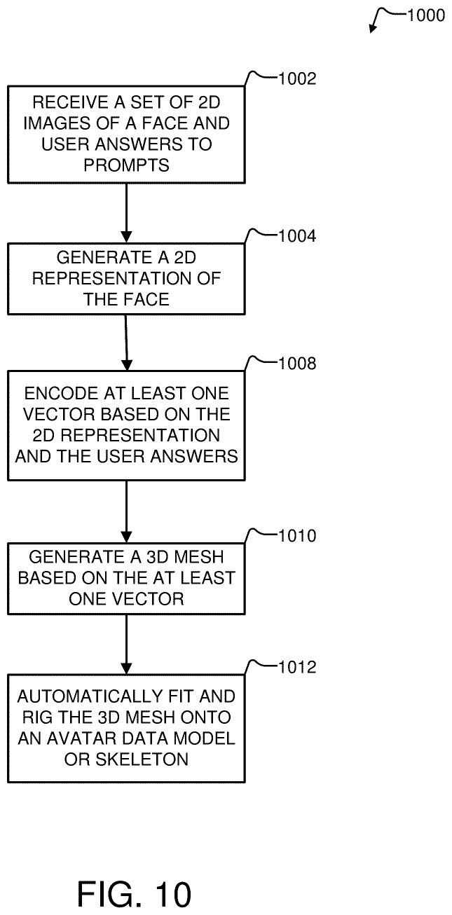

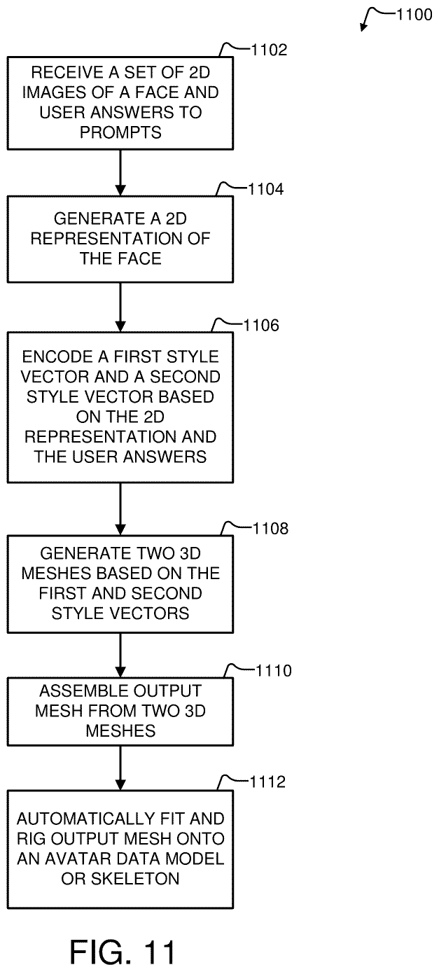

### FIGS. 10-11: Methods to Automatically Generate Avatars

FIG. 10 is a flowchart of an example method of automatic personalized avatar generation from 2D images, in accordance with some implementations. In some implementations, method 1000 can be implemented, for example, on a server system, e.g., online virtual experience platform 102 as shown in FIG. 1, and/or with a generative pipeline arranged as in FIG. 2C. In some implementations, some or all of the method 1000 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 1000.

To provide avatar generation, a face from an input image may be detected and/or processed by a trained machine-learning model or models. Prior to performing face detection or analysis, the user is provided an indication that such techniques are utilized for avatar generation. If the user denies permission, automatic generation based on input images is turned off (e.g., default characters may be used, or no avatar may be generated). The user provided images are utilized specifically for avatar generation and are not stored. The user can turn off image analysis and automatic avatar generation at any time. Further, facial detection may be performed to encode features of the face within the images; no facial recognition is performed. If the user permits use of analysis for avatar generation, method 1000 begins at block 1102.

At block 1002, a set of input 2D images that capture a face and user answers/prompts are received. For example, the images may be 2-dimensional (2D). For example, the images may include a left perspective image, a front facing image, and a right perspective image. For example, the input images and associated perspectives/viewpoints may be based on computer-generated training images provided for training of the generative component 107. In some implementations, the set of input images include two or more images (e.g., of a user face or another face), and the method includes capturing, at an imaging sensor in operative communication with a user device, the two or more images of the face, receiving, from the user, permission to transmit the two or more images to a virtual experience platform; and transmitting, from the user device, the two or more images to the virtual experience platform. Block 1102 is followed by block 1004.

At block 1004, a 2D representation of the face is generated by a trained neural network. The 2D representation may be based on the input images, but may also be entirely computer-generated. In this manner, the 2D representation may be used as a base for an avatar's face, but also be augmented to include personalized features, in some implementations. For example, the generating of the 2D may may include receiving, by the personalization encoder, the set of input images; outputting, by the personalization encoder, a feature vector of the face depicted in the set of input images, wherein the feature vector is specific to the face and is different from feature vectors of other faces; receiving, by the neural network, the feature vector; and outputting, by the neural network and based on the feature vector, the 2D representation. Block 1004 is followed by block 1008.

At block 1008, a style vector is encoded based upon the 2D representation and/or user answers/prompts to one or more prompts (e.g., “what style do you like?”, “what is your desired style?”, etc.). The style vector may be encoded by a trained style encoder that is trained to output a conditional density sampling based upon outputs of a trained GAN network or a trained GAN generator such as generator 244. For example, if no user answers/prompts are provided, the style vector may be based on features detected in the 2D representation. If one or more user answers/prompts are provided, the style vector may include features extracted based on the user answers/prompts as well as the 2D representation.

For example, encoding the style vector may include receiving, by the style encoder, the 2D representation; identifying, by the style encoder, parameterizations of the GAN; and encoding, by the style encoder, the conditional sampling vector with a conditional density sampling of style features based upon the one or more user provided answers, the 2D representation, and the parameterizations. Block 1008 is followed by block 1010.

At block 1010, a 3D mesh is generated by the trained GAN generator, based on the input style vector/conditional sampling vector. For example, generating the mesh can include receiving, by the GAN, the conditional sampling vector; and outputting, by the GAN, a tri-plane data structure that represents the 3D mesh in response to receiving the conditional sampling vector. Block 1010 is followed by block 1012.

At block 1012, the generated 3D mesh is automatically fit and rigged onto an avatar data model and/or avatar skeleton for deployment at a virtual experience platform or another platform. For example, automatically fitting and rigging may include adjusting, by a topology fitting algorithm, the 3D mesh for a particular head topology; texturing, by a multiview texturing algorithm, the adjusted mesh to create a textured mesh; and rigging, by the automatic rigging algorithm, the textured mesh onto the avatar data model.

In some implementations, the method may also include fitting body features onto an avatar. For example, the method may also include extracting, from the set of input images, body features of a body associated with the face; and applying the extracted body features to the rigged avatar data model that includes the textured mesh to create an animatable full body avatar for a user/face represented in the set of input images. Other variations may also be applicable.

As described above, the method 1000 may be a computer-implemented method, and may include receiving a set of input images; generating, by at least a personalization encoder and a neural network, a two-dimensional (2D) computer-generated representation of a face depicted in the input images; encoding, by a style encoder, a style vector as a conditional sampling vector for input to a generative-adversarial network (GAN), the encoding based upon the 2D computer-generated representation and one or more user provided answers to one or more prompts; generating, by the GAN, data representing a 3D mesh of a personalized avatar face based on the conditional sampling vector; and automatically fitting and rigging the 3D mesh onto a head of an avatar data model.

The method 1000 and associated blocks 1002-1012 may be varied in many ways, to include features disclosed throughout the specification and clauses, and to include features from different implementations. Furthermore, the method 1000 may be arranged as computer-executable code stored on a computer-readable storage medium and/or may be arranged to be executed as a sequence or set or operations by a processing device or a computer device. Other variations are also applicable.

Blocks 1002-1012 can be performed (or repeated) in a different order than described above and/or one or more blocks can be omitted. Method 1000 can be performed on a server (e.g., 102) and/or a client device (e.g., 110 or 116). Furthermore, portions of the method 1000 may be combined and performed in sequence or in parallel, according to any desired implementation.

Hereinafter, an additional method of automatic avatar generation (e.g., with a dual-GAN generator) is described in detail. FIG. 11 is a flowchart of another example method 1100 of automatic personalized avatar generation from 2D images, in accordance with some implementations.

In some implementations, method 1100 can be implemented, for example, on a server system, e.g., online virtual experience platform 102 as shown in FIG. 1 and/or with a generative pipeline arranged as in FIG. 2D. In some implementations, some or all of the method 1100 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 1100.

To provide avatar generation in this and other examples, a face from an input image may be detected and/or processed by a trained machine-learning model or models. Prior to performing face detection or analysis, the user is provided an indication that such techniques are utilized for avatar generation. If the user denies permission, automatic generation based on input images is turned off (e.g., default characters may be used, or no avatar may be generated). The user provided images are utilized specifically for avatar generation and are not stored. The user can turn off image analysis and automatic avatar generation at any time. Further, facial detection may be performed to encode features of the face within the images; no facial recognition is performed. If the user permits use of analysis for avatar generation, method 1100 begins at block 1102.

At block 1102, a set of input 2D images that capture a face and user answers/prompts are received. For example, the images may be 2D images captured at an imaging device, such as a camera or with a cellphone. For example, the images may include a left perspective image, a front facing image, and a right perspective image. For example, the input images and associated perspectives/viewpoints may be based on computer-generated training images provided for training of the generative component 107. Block 1102 is followed by block 1104.

At block 1104, a 2D representation of the face is generated by a trained neural network. The 2D representation may be based on the input images, but may be entirely computer-generated, in some implementations. In this manner, the 2D representation may be used as a base for an avatar's face, but also be augmented to include personalized features. Block 1104 is followed by block 1106.

At block 1106, at least two style vectors are encoded based upon the 2D representation and/or user answers/prompts to one or more prompts (e.g., “what style do you like?”, “what is your desired style?”, etc.). The style vectors may be encoded by a trained style and content encoder that is trained to output conditional density sampling based upon outputs of a trained dual-GAN generator.

In some implementations, a first style vector represents a head that is bald, or a head that does not include hair. Accordingly, the first style vector may not encode hair features. In one implementation, the second style vector represents hair features and is concatenated with encoded features from the first style vector. Accordingly, the second style vector includes encoded features related to both of the head and the hair as encoded from the 2D representation.

In some implementations, encoding the first style vector comprises: receiving, by the style encoder, the 2D representation; identifying, by the style encoder, parameterizations of the first GAN; and encoding, by the style encoder, the first style vector with a conditional density sampling of style features unrelated to hair and based upon the 2D representation and based on the parameterizations.

In some implementations, encoding the second style vector comprises: receiving, by the style encoder, the 2D representation; identifying, by the style encoder, parameterizations of the second GAN; and encoding, by the style encoder, the second style vector with a conditional density sampling of style features related to hair depicted in the 2D representation and based on the parameterizations. Block 1106 is followed by block 1108.

At block 1108, two data structures representing 3D meshes are generated by the trained dual-GAN generator, based on the input style vector/conditional sampling vectors. For example, the first 3D mesh may depict a bald head and the second 3D mesh may depict disembodied hair, in some implementations. Both data structures may be tri-planes or tri-grids, in some implementations.

In some implementations, first data representing the first 3D mesh is a first tri-plane data structure, second data representing the second 3D mesh is a second tri-plane data structure, and the first tri-plane data structure and the second tri-plane data structure are unique. Additionally, the method 1100 can also include outputting, by an opacity decoder, first decoded data from the first tri-plane data structure and second decoded data from the second tri-plane data structure. In this and other examples, the method 1100 can also include generating, by a low-resolution rendering network, the first 3D mesh based on the first decoded data; and generating, by a high-resolution rendering network, the second 3D mesh based on the second decoded data.

In some implementations, the low-resolution rendering network includes a rendering algorithm configured to render a 3D mesh of a bald head, and the high-resolution rendering network comprises a differential renderer coupled to a super-resolution neural network, the high-resolution rendering network configured to render a 3D mesh of hair that matches spatial dimensions of the bald head. Block 1108 is followed by block 1110.

At block 1110, an output mesh is assembled from the two generated 3D meshes. For example, as one mesh represents hair, and the other a bald head, the mesh representing the hair is joined with the bald head to produce an output mesh that represents a head with hair. Block 1110 is followed by block 1112

At block 1112, the output 3D mesh is automatically fit and rigged onto an avatar data model and/or avatar skeleton for deployment at a virtual experience platform or another platform. In some implementations, the automatic fitting and rigging may include adjusting, by a topology fitting algorithm, the output mesh for a particular head topology; texturing, by a multiview texturing algorithm, the adjusted output mesh to create a textured output mesh; and rigging, by an automatic rigging algorithm, the textured output mesh onto the avatar data model.

As described above, method 1100 may be a computer-implemented method, and may include receiving a plurality of input images; generating, by at least a first encoder, a two-dimensional (2D) computer-generated representation of a face depicted in the plurality of input images; encoding, by a style encoder, a first style vector for input to a first generative-adversarial network (GAN) and a second GAN, the encoding based upon the 2D computer-generated representation and encoding features unrelated to hair depicted in the 2D computer-generated representation; encoding, by the style encoder, a second style vector for input to the second GAN, the encoding based upon the 2D computer-generated representation and encoding features related to hair depicted in the 2D computer-generated representation; generating, by the first GAN, first data representing a first 3D mesh of a personalized avatar face based on the first style vector; generating, by the second GAN, second data representing a second 3D mesh of the hair based on the first style vector and the second style vector; joining the first 3D mesh and the second 3D mesh to create an output mesh; and automatically fitting and rigging the output mesh onto a head of an avatar data model.

The method 1100 and associated blocks 1102-1112 may be varied in many ways, to include features disclosed throughout the specification and clauses, and to include features from different implementations. Furthermore, the method 1100 may be arranged as computer-executable code stored on a computer-readable storage medium and/or may be arranged to be executed as a sequence or set or operations by a processing device or a computer device. Other variations are also applicable.

Blocks 1102-1112 can be performed (or repeated) in a different order than described above and/or one or more blocks can be omitted. Method 1100 can be performed on a server (e.g., 102) and/or a client device (e.g., 110 or 116). Furthermore, portions of the method 1100 may be combined and performed in sequence or in parallel, according to any desired implementation.

Hereinafter, a more detailed description of various computing devices that may be used to implement different devices and components illustrated in FIGS. 1-11 is provided with reference to FIG. 4.

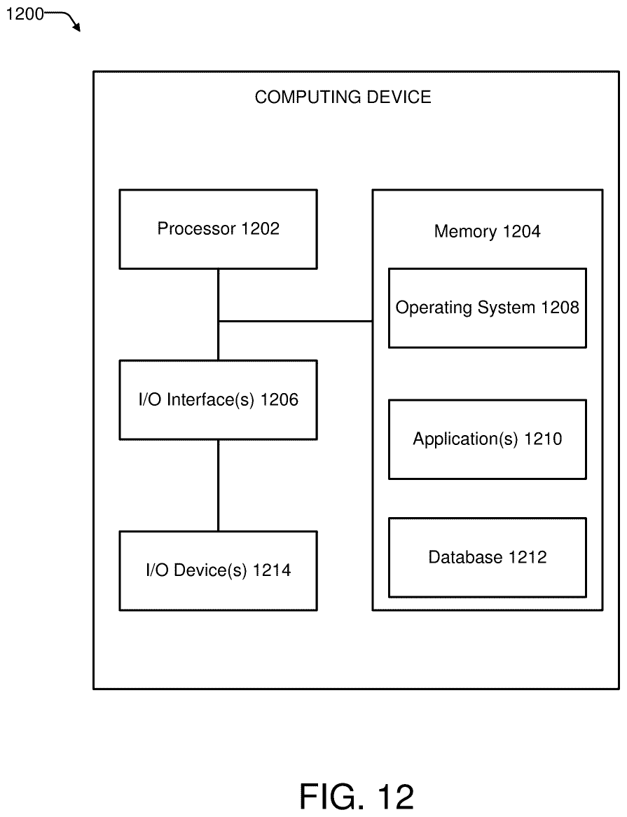

### FIG. 12: Example Computing Device

FIG. 12 is a block diagram of an example computing device 1200 which may be used to implement one or more features described herein, in accordance with some implementations. In one example, device 400 may be used to implement a computer device, (e.g., 102, 110, and/or 116 of FIG. 1), and perform appropriate method implementations described herein. Computing device 1200 can be any suitable computer system, server, or other electronic or hardware device. For example, the computing device 1200 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1200 includes a processor 1202, a memory 1204, input/output (I/O) interface 1206, and audio/video input/output devices 1214 (e.g., display screen, touchscreen, display goggles or glasses, audio speakers, microphone, etc.).

Processor 1202 can be one or more processors and/or processing circuits to execute program code and control basic operations of the device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in device 1200 for access by the processor 1202, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1202 and/or integrated therewith. Memory 1204 can store software operating on the server device 1200 by the processor 1202, including an operating system 1208, an application 1210 and associated data 1212. In some implementations, the application 1210 can include instructions that enable processor 1202 to perform the functions described herein, e.g., some or all of the methods of FIGS. 7-11. In some implementations, the application 1210 may also include one or more trained models for automatically generating a stylized or customized or personalized 3D avatar based on input 2D images and/or answers/prompts to one or more prompts, as described herein.

For example, memory 1204 can include software instructions for an application 1210 that can provide automatically generated avatars based on a user's preferences, within an online virtual experience platform (e.g., 102). Any of software in memory 1204 can alternatively be stored on any other suitable storage location or computer-readable medium. In addition, memory 1204 (and/or other connected storage device(s)) can store instructions and data used in the features described herein. Memory 1204 and any other type of storage (magnetic disk, optical disk, magnetic tape, or other tangible media) can be considered “storage” or “storage devices.”

I/O interface 1206 can provide functions to enable interfacing the server device 1200 with other systems and devices. For example, network communication devices, storage devices (e.g., memory and/or data store 108), and input/output devices can communicate via interface 1206. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 12 shows one block for each of processor 1202, memory 1204, I/O interface 1206, software blocks 1208 and 1210, and database 1212. These blocks may represent one or more processors or processing circuitries, operating systems, memories, I/O interfaces, applications, and/or software modules. In other implementations, device 1200 may not have all of the components shown and/or may have other elements including other types of elements instead of, or in addition to, those shown herein. While the online virtual experience platform 102 is described as performing operations as described in some implementations herein, any suitable component or combination of components of online virtual experience platform 102 or similar system, or any suitable processor or processors associated with such a system, may perform the operations described.

A user device can also implement and/or be used with features described herein. Example user devices can be computer devices including some similar components as the device 1200, e.g., processor(s) 1202, memory 1204, and I/O interface 1206. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1214, for example, can be connected to (or included in) the device 1200 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 700, 800, 900, 1000, 1100, and 1200) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

### EXAMPLE CLAUSES

Clause 1. A computer-implemented method, comprising: receiving a set of input images; generating, by at least a personalization encoder and a neural network, a two-dimensional (2D) computer-generated representation of a face depicted in the input images; encoding, by a style encoder, a style vector as a conditional sampling vector for input to a generative-adversarial network (GAN), the encoding based upon the 2D computer-generated representation and one or more user provided answers to one or more prompts; generating, by the GAN, data representing a 3D mesh of a personalized avatar face based on the conditional sampling vector; and automatically fitting and rigging the 3D mesh onto a head of an avatar data model.

Clause 2. The subject matter according to any preceding clause, wherein generating the 2D computer-generated representation comprises: receiving, by the personalization encoder, the set of input images; outputting, by the personalization encoder, a feature vector of the face depicted in the set of input images, wherein the feature vector is specific to the face and is different from feature vectors of other faces; receiving, by the neural network, the feature vector; and outputting, by the neural network and based on the feature vector, the 2D representation.

Clause 3. The subject matter according to any preceding clause, wherein encoding the style vector comprises: receiving, by the style encoder, the 2D representation; identifying, by the style encoder, parameterizations of the GAN; and encoding, by the style encoder, the conditional sampling vector with a conditional density sampling of style features based upon the one or more user provided answers, the 2D representation, and the parameterizations.

Clause 4. The subject matter according to any preceding clause, wherein generating the 3D mesh comprises: receiving, by the GAN, the conditional sampling vector; and outputting, by the GAN, a tri-plane data structure that represents the 3D mesh in response to receiving the conditional sampling vector.

Clause 5. The subject matter according to any preceding clause, further comprising: receiving, by a multi-plane renderer, the data representative of the 3D mesh from the GAN; and outputting, by the multi-plane renderer, a scalar field representative of the 3D mesh.

Clause 6. The subject matter according to any preceding clause, further comprising: receiving, by a trained mesh generation algorithm, the scalar field; and outputting, by the trained mesh generation algorithm, the 3D mesh as a polygonal mesh of an iso-surface represented by the scalar field.

Clause 7. The subject matter according to any preceding clause, wherein the personalization encoder, neural network, style encoder, and GAN are deployed at a virtual experience platform, and wherein the avatar data model corresponds to an avatar that participates in a virtual experience presented through the virtual experience platform, wherein the avatar is animatable.

Clause 8. The subject matter according to any preceding clause, wherein the automatically fitting and rigging comprises: adjusting, by a topology fitting algorithm, the 3D mesh for a particular head topology; texturing, by a multiview texturing algorithm, the adjusted mesh to create a textured mesh; and rigging, by the automatic rigging algorithm, the textured mesh onto the avatar data model.

Clause 9. The subject matter according to any preceding clause, further comprising: extracting, from the set of input images, body features of a body associated with the face; and applying the extracted body features to the rigged avatar data model that includes the textured mesh to create an animatable full body avatar for a user represented in the set of input images.

Clause 10. The subject matter according to any preceding clause, wherein the set of input images include two or more images of a user's face, and the method further comprises: capturing, at an imaging sensor in operative communication with a user device, the two or more images of the user's face; receiving, from the user, permission to transmit the two or more images to a virtual experience platform; and transmitting, from the user device, the two or more images to the virtual experience platform.

Clause 11. A system comprising: a memory with instructions stored thereon; and a processing device, coupled to the memory, the processing device configured to access the memory and execute the instructions, wherein the instructions cause the processing device to perform operations comprising: receiving a set of input images; generating, by at least a personalization encoder and a neural network, a two-dimensional (2D) computer-generated representation of a face depicted in the input images; encoding, by a style encoder, a style vector as a conditional sampling vector for input to a generative-adversarial network (GAN), the encoding based upon the 2D computer-generated representation and one or more user provided answers to one or more prompts; generating, by the GAN, data representing a 3D mesh of a personalized avatar face based on the conditional sampling vector; and automatically fitting and rigging the 3D mesh onto a head of an avatar data model.

Clause 12. The subject matter according to any preceding clause, wherein generating the 2D computer-generated representation comprises: receiving, by the personalization encoder, the set of input images; outputting, by the personalization encoder, a feature vector of the face depicted in the set of input images, wherein the feature vector is specific to the face and is different from feature vectors of other faces; receiving, by the neural network, the feature vector; and outputting, by the neural network and based on the feature vector, the 2D representation.

Clause 13. The subject matter according to any preceding clause, wherein encoding the style vector comprises: receiving, by the style encoder, the 2D representation; identifying, by the style encoder, parameterizations of the GAN; and encoding, by the style encoder, the conditional sampling vector with a conditional density sampling of style features based upon the one or more user provided answers, the 2D representation, and the parameterizations.

Clause 14. The subject matter according to any preceding clause, wherein generating the 3D mesh comprises: receiving, by the GAN, the conditional sampling vector; and outputting, by the GAN, a tri-plane data structure that represents the 3D mesh in response to receiving the conditional sampling vector.

Clause 15. The subject matter according to any preceding clause, wherein the operations further comprise: receiving, by a multi-plane renderer, the data representative of the 3D mesh from the GAN; and outputting, by the multi-plane renderer, a scalar field based on the data received from the GAN.

Clause 16. The subject matter according to any preceding clause, wherein the operations further comprise: receiving, by a trained mesh generation algorithm, the scalar field; and outputting, by the trained mesh generation algorithm, the 3D mesh as a polygonal mesh of an iso-surface represented by the scalar field.

Clause 17. The subject matter according to any preceding clause, wherein the personalization encoder, neural network, style encoder, and GAN are deployed at a virtual experience platform, and wherein the avatar data model corresponds to an avatar that participates in a virtual experience presented through the virtual experience platform, wherein the avatar is animatable.

Clause 18. The subject matter according to any preceding clause, wherein the automatically fitting and rigging comprises: adjusting, by a topology fitting algorithm, the 3D mesh for a particular head topology; texturing, by a multiview texturing algorithm, the adjusted mesh to create a textured mesh; and rigging, by the automatic rigging algorithm, the textured mesh onto the avatar data model.

Clause 19. The subject matter according to any preceding clause, wherein the operations further comprise: extracting, from the set of input images, body features of a body associated with the face; and applying the extracted body features to the rigged avatar data model that includes the textured mesh to create an animatable full body avatar for a user represented in the set of input images

Clause 20. A non-transitory computer-readable medium with instructions stored thereon that, responsive to execution by a processing device, causes the processing device to perform operations comprising: receiving a training set of input images, wherein each image of the training set is a computer-generated image containing a respective face and a plurality of features associated with the respective face; for each image of the training set of input images, encoding, by a style encoder, a style vector as a conditional sampling vector for input to a generative-adversarial network (GAN), the encoding based upon a respective image and the plurality of features associated therewith, generating, by the GAN, data representing a 3D mesh of the respective face based on the conditional sampling vector, comparing, by a discriminator in operative communication with the GAN, the data generated by the GAN to the respective face of the respective image, if the comparing indicates a positive comparison, adjusting one or more discriminator parameters of the discriminator, and if the comparing indicates a negative comparison, adjusting one or more GAN parameters of the GAN; and deploying the GAN at a virtual experience platform responsive to convergence of the GAN based on each of the encoding, generating, and comparing.

Clause 21. A computer-implemented method, comprising: receiving a plurality of input images; generating, by at least a first encoder, a two-dimensional (2D) computer-generated representation of a face depicted in the plurality of input images; encoding, by a style encoder, a first style vector for input to a first generative-adversarial network (GAN) and a second GAN, the encoding based upon the 2D computer-generated representation and encoding features unrelated to hair depicted in the 2D computer-generated representation; encoding, by the style encoder, a second style vector for input to the second GAN, the encoding based upon the 2D computer-generated representation and encoding features related to hair depicted in the 2D computer-generated representation; generating, by the first GAN, first data representing a first 3D mesh of a personalized avatar face based on the first style vector; generating, by the second GAN, second data representing a second 3D mesh of the hair based on the first style vector and the second style vector; joining the first 3D mesh and the second 3D mesh to create an output mesh; and automatically fitting and rigging the output mesh onto a head of an avatar data model.

Clause 22. The subject matter according to any preceding clause, wherein the first 3D mesh depicts a bald head and the second 3D mesh depicts disembodied hair.

Clause 23. The subject matter according to any preceding clause, wherein encoding the first style vector comprises: receiving, by the style encoder, the 2D representation; identifying, by the style encoder, parameterizations of the first GAN; and encoding, by the style encoder, the first style vector with a conditional density sampling of style features unrelated to hair and based upon the 2D representation and based on the parameterizations.

Clause 24. The subject matter according to any preceding clause, wherein encoding the second style vector comprises: receiving, by the style encoder, the 2D representation; identifying, by the style encoder, parameterizations of the second GAN; and encoding, by the style encoder, the second style vector with a conditional density sampling of style features related to hair depicted in the 2D representation and based on the parameterizations.

Clause 25. The subject matter according to any preceding clause, wherein the first data representing the first 3D mesh is a first tri-plane data structure, wherein the second data representing the second 3D mesh is a second tri-plane data structure, and wherein the first tri-plane data structure and the second tri-plane data structure are unique, the computer-implemented method further comprising: outputting, by an opacity decoder, first decoded data from the first tri-plane data structure and second decoded data from the second tri-plane data structure.

Clause 26. The subject matter according to any preceding clause, further comprising: generating, by a low-resolution rendering network, the first 3D mesh based on the first decoded data; and generating, by a high-resolution rendering network, the second 3D mesh based on the second decoded data.

Clause 27. The subject matter according to any preceding clause, wherein the low-resolution rendering network comprising a rendering algorithm configured to render a 3D mesh of a bald head, and wherein the high-resolution rendering network comprises a differential renderer coupled to a super-resolution neural network, the high-resolution rendering network configured to render a 3D mesh of hair that matches spatial dimensions of the bald head.

Clause 28. The subject matter according to any preceding clause, wherein the first encoder, style encoder, first GAN, and second GAN are deployed at a virtual experience platform, and wherein the plurality of input images are associated with and stored at the virtual experience platform.

Clause 29. The subject matter according to any preceding clause, wherein the automatically fitting and rigging comprises: adjusting, by a topology fitting algorithm, the output mesh for a particular head topology; texturing, by a multiview texturing algorithm, the adjusted output mesh to create a textured output mesh; and rigging, by an automatic rigging algorithm, the textured output mesh onto the avatar data model.

Clause 30. A system comprising: a memory with instructions stored thereon; and a processing device, coupled to the memory, the processing device configured to access the memory and execute the instructions, wherein the instructions cause the processing device to perform operations comprising: receiving a plurality of input images; generating, by at least a first encoder, a two-dimensional (2D) computer-generated representation of a face depicted in the plurality of input images; encoding, by a style encoder, a first style vector for input to a first generative-adversarial network (GAN) and a second GAN, the encoding based upon the 2D computer-generated representation and encoding features unrelated to hair depicted in the plurality of input images; encoding, by the style encoder, a second style vector for input to the second GAN, the encoding based upon the 2D computer-generated representation and encoding features related to hair depicted in the plurality of input images; generating, by the first GAN, first data representing a first 3D mesh of a personalized avatar face based on the first style vector; generating, by the second GAN, second data representing a second 3D mesh of the hair based on the first style vector and the second style vector; joining the first 3D mesh and the second 3D mesh to create an output mesh; and automatically fitting and rigging the output mesh onto a head of an avatar data model.

Clause 31. The subject matter according to any preceding clause, wherein the first 3D mesh depicts a bald head and the second 3D mesh depicts disembodied hair.

Clause 32. The subject matter according to any preceding clause, wherein encoding the first style vector comprises: receiving, by the style encoder, the 2D representation; identifying, by the style encoder, parameterizations of the first GAN; and encoding, by the style encoder, the first style vector with a conditional density sampling of style features unrelated to hair and based upon the 2D representation and based on the parameterizations.

Clause 33. The subject matter according to any preceding clause, wherein encoding the second style vector comprises: receiving, by the style encoder, the 2D representation; identifying, by the style encoder, parameterizations of the second GAN; and encoding, by the style encoder, the second style vector with a conditional density sampling of style features related to hair depicted in the 2D representation and based on the parameterizations.

Clause 34. The subject matter according to any preceding clause, wherein the first data representing the first 3D mesh is a first tri-plane data structure, wherein the second data representing the second 3D mesh is a second tri-plane data structure, and wherein the first tri-plane data structure and the second tri-plane data structure are unique, the operations further comprising: outputting, by an opacity decoder, first decoded data from the first tri-plane data structure and second decoded data from the second tri-plane data structure.

Clause 35. The subject matter according to any preceding clause, wherein the operations further comprise: generating, by a low-resolution rendering network, the first 3D mesh based on the first decoded data; and generating, by a high-resolution rendering network, the second 3D mesh based on the second decoded data.

Clause 36. The subject matter according to any preceding clause, wherein the low-resolution rendering network comprising a rendering algorithm configured to render a 3D mesh of a bald head, and wherein the high-resolution rendering network comprises a differential renderer coupled to a super-resolution neural network, the high-resolution rendering network configured to render a 3D mesh of hair that matches spatial dimensions of the bald head.

Clause 37. The subject matter according to any preceding clause, wherein the first encoder, style encoder, first GAN, and second GAN are deployed at a virtual experience platform, and wherein the plurality of input images are associated with and stored at the virtual experience platform.

Clause 38. The subject matter according to any preceding clause, wherein the automatically fitting and rigging comprises: adjusting, by a topology fitting algorithm, the output mesh for a particular head topology; texturing, by a multiview texturing algorithm, the adjusted output mesh to create a textured output mesh; and rigging, by an automatic rigging algorithm, the textured output mesh onto the avatar data model.

Clause 39. A non-transitory computer-readable medium with instructions stored thereon that, responsive to execution by a processing device, causes the processing device to perform operations comprising: receiving a plurality of input images, wherein each image of the plurality of input images depicts the same face, and wherein each image of the plurality of input images is a computer-generated two-dimensional image; encoding, by a style encoder, a first style vector for input to a first generative-adversarial network (GAN) and a second GAN, the encoding based upon the plurality of input images and encoding features unrelated to hair depicted in the plurality of input images; encoding, by the style encoder, a second style vector for input to the second GAN, the encoding based upon the plurality of input images and encoding features related to hair depicted in the plurality of input images; generating, by the first GAN, first data representing a first 3D mesh of a personalized avatar face based on the first style vector; generating, by the second GAN, second data representing a second 3D mesh of the hair based on the first style vector and the second style vector; joining the first 3D mesh and the second 3D mesh to create an output mesh; and automatically fitting and rigging the output mesh onto a head of an avatar data model.

Clause 40. The subject matter according to any preceding clause, wherein: encoding the first style vector comprises: receiving, by the style encoder, a 2D representation of the plurality of input images, identifying, by the style encoder, parameterizations of the first GAN, and encoding, by the style encoder, the first style vector with a conditional density sampling of style features unrelated to hair and based upon the 2D representation and based on the parameterizations of the first GAN; and encoding the second style vector comprises: identifying, by the style encoder, parameterizations of the second GAN, and encoding, by the style encoder, the second style vector with a conditional density sampling of style features related to hair depicted in the 2D representation and based on the parameterizations of the second GAN.

### CONCLUSION

Although the description has been described with respect to particular implementations thereof, these particular implementations are merely illustrative, and not restrictive. Concepts illustrated in the examples may be applied to other examples and implementations.

In situations in which certain implementations discussed herein may obtain or use user data (e.g., images of users, user demographics, user behavioral data on the platform, user search history, items purchased and/or viewed, user's friendships on the platform, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method, comprising:
receiving a set of input images;
generating, by at least a personalization encoder and a neural network, a two-dimensional (2D) computer-generated representation of a face depicted in the input images;
encoding, by a style encoder, a style vector as a conditional sampling vector for input to a generative-adversarial network (GAN), the encoding based upon the 2D computer-generated representation and one or more user provided answers to one or more prompts;
generating, by the GAN, data representing a 3D mesh of a personalized avatar face based on the conditional sampling vector; and
automatically fitting and rigging the 3D mesh onto a head of an avatar data model.

2. The computer-implemented method of claim 1, wherein generating the 2D computer-generated representation comprises:
receiving, by the personalization encoder, the set of input images;
outputting, by the personalization encoder, a feature vector of the face depicted in the set of input images, wherein the feature vector is specific to the face and is different from feature vectors of other faces;
receiving, by the neural network, the feature vector; and
outputting, by the neural network and based on the feature vector, the 2D representation.

3. The computer-implemented method of claim 1, wherein encoding the style vector comprises:
receiving, by the style encoder, the 2D representation;
identifying, by the style encoder, parameterizations of the GAN; and
encoding, by the style encoder, the conditional sampling vector with a conditional density sampling of style features based upon the one or more user provided answers, the 2D representation, and the parameterizations.

4. The computer-implemented method of claim 1, wherein generating the 3D mesh comprises:
receiving, by the GAN, the conditional sampling vector; and
outputting, by the GAN, a tri-plane data structure that represents the 3D mesh in response to receiving the conditional sampling vector.

5. The computer-implemented method of claim 1, further comprising:
receiving, by a multi-plane renderer, the data representative of the 3D mesh from the GAN; and
outputting, by the multi-plane renderer, a scalar field representative of the 3D mesh.

6. The computer-implemented method of claim 5, further comprising:
receiving, by a trained mesh generation algorithm, the scalar field; and
outputting, by the trained mesh generation algorithm, the 3D mesh as a polygonal mesh of an iso-surface represented by the scalar field.

7. The computer-implemented method of claim 1, wherein the personalization encoder, neural network, style encoder, and GAN are deployed at a virtual experience platform, and wherein the avatar data model corresponds to an avatar that participates in a virtual experience presented through the virtual experience platform, wherein the avatar is animatable.

8. The computer-implemented method of claim 1, wherein the automatically fitting and rigging comprises:
adjusting, by a topology fitting algorithm, the 3D mesh for a particular head topology;
texturing, by a multiview texturing algorithm, the adjusted mesh to create a textured mesh; and
rigging, by the automatic rigging algorithm, the textured mesh onto the avatar data model.

9. The computer-implemented method of claim 8, further comprising:
extracting, from the set of input images, body features of a body associated with the face; and
applying the extracted body features to the rigged avatar data model that includes the textured mesh to create an animatable full body avatar for a user represented in the set of input images.

10. The computer-implemented method of claim 1, wherein the set of input images include two or more images of a user's face, and the method further comprises:
capturing, at an imaging sensor in operative communication with a user device, the two or more images of the user's face;
receiving, from the user, permission to transmit the two or more images to a virtual experience platform; and
transmitting, from the user device, the two or more images to the virtual experience platform.

11. A system comprising:
a memory with instructions stored thereon; and
a processing device, coupled to the memory, the processing device configured to access the memory and execute the instructions, wherein the instructions cause the processing device to perform operations comprising:
receiving a set of input images;
generating, by at least a personalization encoder and a neural network, a two-dimensional (2D) computer-generated representation of a face depicted in the input images;
encoding, by a style encoder, a style vector as a conditional sampling vector for input to a generative-adversarial network (GAN), the encoding based upon the 2D computer-generated representation and one or more user provided answers to one or more prompts;
generating, by the GAN, data representing a 3D mesh of a personalized avatar face based on the conditional sampling vector; and
automatically fitting and rigging the 3D mesh onto a head of an avatar data model.

12. The system of claim 11, wherein generating the 2D computer-generated representation comprises:
receiving, by the personalization encoder, the set of input images;
outputting, by the personalization encoder, a feature vector of the face depicted in the set of input images, wherein the feature vector is specific to the face and is different from feature vectors of other faces;
receiving, by the neural network, the feature vector; and
outputting, by the neural network and based on the feature vector, the 2D representation.

13. The system of claim 11, wherein encoding the style vector comprises:
receiving, by the style encoder, the 2D representation;
identifying, by the style encoder, parameterizations of the GAN; and
encoding, by the style encoder, the conditional sampling vector with a conditional density sampling of style features based upon the one or more user provided answers, the 2D representation, and the parameterizations.

14. The system of claim 11, wherein generating the 3D mesh comprises:
receiving, by the GAN, the conditional sampling vector; and
outputting, by the GAN, a tri-plane data structure that represents the 3D mesh in response to receiving the conditional sampling vector.

15. The system of claim 11, wherein the operations further comprise:
receiving, by a multi-plane renderer, the data representative of the 3D mesh from the GAN; and
outputting, by the multi-plane renderer, a scalar field based on the data received from the GAN.

16. The system of claim 15, wherein the operations further comprise:
receiving, by a trained mesh generation algorithm, the scalar field; and
outputting, by the trained mesh generation algorithm, the 3D mesh as a polygonal mesh of an iso-surface represented by the scalar field.

17. The system of claim 11, wherein the personalization encoder, neural network, style encoder, and GAN are deployed at a virtual experience platform, and wherein the avatar data model corresponds to an avatar that participates in a virtual experience presented through the virtual experience platform, wherein the avatar is animatable.

18. The system of claim 11, wherein the automatically fitting and rigging comprises:
adjusting, by a topology fitting algorithm, the 3D mesh for a particular head topology;
texturing, by a multiview texturing algorithm, the adjusted mesh to create a textured mesh; and
rigging, by the automatic rigging algorithm, the textured mesh onto the avatar data model.

19. The system of claim 18, wherein the operations further comprise:
extracting, from the set of input images, body features of a body associated with the face; and
applying the extracted body features to the rigged avatar data model that includes the textured mesh to create an animatable full body avatar for a user represented in the set of input images

20. A non-transitory computer-readable medium with instructions stored thereon that, responsive to execution by a processing device, causes the processing device to perform operations comprising:
receiving a training set of input images, wherein each image of the training set is a computer-generated image containing a respective face and a plurality of features associated with the respective face;
for each image of the training set of input images,
encoding, by a style encoder, a style vector as a conditional sampling vector for input to a generative-adversarial network (GAN), the encoding based upon a respective image and the plurality of features associated therewith,
generating, by the GAN, data representing a 3D mesh of the respective face based on the conditional sampling vector,
comparing, by a discriminator in operative communication with the GAN, the data generated by the GAN to the respective face of the respective image,
if the comparing indicates a positive comparison, adjusting one or more discriminator parameters of the discriminator, and
if the comparing indicates a negative comparison, adjusting one or more GAN parameters of the GAN; and
deploying the GAN at a virtual experience platform responsive to convergence of the GAN based on each of the encoding, generating, and comparing.

21.-40. (canceled)
